(19) United States
(12) Patent Application Publication
(10) Pub. No.: US 2007/0038642 A1
(43) Pub. Date: Feb. 15, 2007

(54) Method for providing extensible software components within a distributed synchronization system

(76) Inventors: Scott Durgin, North Andover, MA (US); Michael G. Palone, Waltham, MA (US); Phil Stanhope, Newbury, MA (US); Mikhail Chekmarev, Arlington, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 11/501,475

(22) Filed: Aug. 9, 2006

Related U.S. Application Data
(63) Continuation-in-part of application No. 11/229,486, filed on Sep. 15, 2005, now abandoned.
(63) Continuation-in-part of application No. 11/229,311, filed on Sep. 15, 2005.
(60) Provisional application No. 60/706,552, filed on Aug. 9, 2005.
(60) Provisional application No. 60/609,990, filed on Sep. 15, 2004.
(60) Provisional application No. 60/610,016, filed on Sep. 15, 2004.
(60) Provisional application No. 60/609,948, filed on Sep. 15, 2004.
(60) Provisional application No. 60/609,989, filed on Sep. 15, 2004.
(60) Provisional application No. 60/610,079, filed on Sep. 15, 2004.
(60) Provisional application No. 60/707,837, filed on Aug. 12, 2005.

(51) Int. Cl. G06F 17/30

(52) U.S. Cl. 707/10

(57) ABSTRACT

A synchronization system is provided that distributes synchronization system-based applications and synchronization system-based application extensions and their associated resources and components (hereinafter “plug-in applications” or “plug-ins”). Components are maintained such that any synchronization system-based application instantiation may be changed or updated by the synchronization system. In one specific example using the synchronization system, each synchronization system-based application or plug-in is self-contained and self-updateable through a synchronization system synchronization process. A further benefit is that the synchronization system and synchronization system-based applications may be extended independent of device type or operating system. Thus, a system is provided for synchronizing one or more plug-in applications. In one example, the system for synchronizing plug-in applications includes a synchronization system having at least one distributed database that is configured to store a plug-in application, and a schema for the database. Optionally, the distributed database may be configured to store plug-in application instantiation information, synchronization system-based application association information, role, permissions, access control rights, and data associated with the plug-in application. In one example, each distributed database has at least two instances, and the plug-in application (and optional resources and components) is stored in at least one instance of the distributed database. As described herein, the synchronization system is configured to synchronize the plug-in application (and optional resources and components) between the instances of said distributed database.

### RELATED APPLICATIONS

This application claims priority under 35 U.S.C. § 119(e) to U.S. Provisional Application Ser. No. 60/706,552 filed Aug. 9, 2005, incorporated herein by reference in its entirety. This application is also a continuation-in-part of U.S. application Ser. No. 11/229,486, filed Sep. 15, 2005, entitled “SYSTEM AND METHOD FOR MANAGING DATA IN A DISTRIBUTED COMPUTER SYSTEM” and is a continuation-in-part of U.S. application Ser. No. 11/229,311, filed Sep. 15, 2005, entitled “SYSTEM AND METHOD FOR MANAGING DATA IN A DISTRIBUTED COMPUTER SYSTEM” both of which claim priority under 35 U.S.C. § 119(e) to U.S. Provisional Application Ser. No. 60/609,990 entitled “SYSTEM AND METHOD FOR LINKING DATA,” filed on Sep. 15, 2004, U.S. Provisional Application Ser. No. 60/610,016 entitled “SYSTEM AND METHOD FOR SHARING CONTENT,” filed on Sep. 15, 2004, U.S. Provisional Application Ser. No. 60/609,948 entitled “SYSTEM AND METHOD FOR SYNCHRONIZING DATA,” filed on Sep. 15, 2004, U.S. Provisional Application Ser. No. 60/609,989 entitled “SYSTEM AND METHOD FOR SHARING CONTENT,” filed on Sep. 15, 2004, U.S. Provisional Application Ser. No. 60/610,079 entitled “SYSTEM AND METHOD FOR AUDITING DATA,” filed on Sep. 15, 2004, and U.S. Provisional Application Ser. No. 60/707,837 entitled “METHOD AND APPARATUS FOR MANAGING DATA IN A DISTRIBUTED NETWORK,” filed on Aug. 12, 2005, each of which applications are herein incorporated by reference in their entirety.

### BACKGROUND

Current synchronization systems are monolithic in nature, and include application deployment mechanisms that do not perform well when synchronizing data and programs across a plurality of devices and applications. Most current synchronization systems synchronize only the data portion or the application portion of an application, leaving the initial deployment of applications, their data, and their configurations to users or system administrators. Furthermore, these systems do not support partial application deployments where the databases or applications must be extended to add functionality or database fields after the initial application has been deployed.

In addition, synchronization-capable systems and applications that support dynamic extension via plug-in component approaches (such as the well-known Internet Explorer and Outlook applications available from the Microsoft Corporation, Redmond, Wash., among other popular business applications) do not support the synchronization of both the application components and the data. For example, the Outlook application may be configured to synchronize the data with a server, but according to one aspect of the present invention, it is appreciated that the Outlook application cannot synchronize any required Outlook application plug-ins at the same time. This imposes a burden on the user and/or system administrator to synchronize the deployment of the system, application plug-ins, and data.

Some synchronization systems can synchronize files, but these systems cannot effectively manage complex data structures such as databases. Also, these systems are unable to synchronize different files to disparate devices on the basis of device, device type, dependencies, or other attributes associated with the data, applications, or plug-ins. Furthermore, current synchronization systems cannot replicate synchronized information between more than two instances of the synchronized information in a manner effective to all the information to be seamlessly synchronized between a multitude of disparate instances. Nor do these applications synchronize applications, application components, application data, and associations between applications to each disparate device utilizing information about the device, device type, or other attributes of the device or application to help determine which components are distributed to which device.

Moreover, most synchronization systems are controlled outside of the application level. For example, the Outlook application synchronizes the complete database (the OST) each time the application synchronizes. Synchronization control occurs at the database level, not at the application level. Such a synchronization control yields simplistic synchronization decisions such as the “remote (server) wins,” “client wins,” and “skip.” According to one aspect of the present invention that is needed is a system that can synchronize information within the context of the application, and in which the application can provide input into the synchronization process. This input may include guidance on whether to synchronize, what aspects to synchronize, how to synchronize, when to synchronize, where to synchronize to, and may even provide the synchronization component itself.

In addition, as deployed applications change, present day synchronization systems do not provide a seamless method of managing the changes in the applications and data, nor do they provide a means to run a plurality of application versions on different devices that require different underlying synchronized data schemas. Thus, what also is needed is a synchronization system that can seamlessly synchronize applications and data, including applications of differing versions that rely on different underlying data and schemas, and seamlessly map these versions to the underlying synchronized databases.

### SUMMARY

According to one aspect of the present invention, in a distributed computing system, a computer-implemented method is provided for associating a software component with a software program. The method comprises acts of identifying, by an identification layer, the software component within the distributed computing system, accessing, by the software program, the software component through the identification layer, and linking the software component to the software program. According to one embodiment of the invention, the act of identifying further comprises an act of uniquely identifying the software component within the distributed computing system. According to another embodiment, the method further comprises an act of relating the software component to a database element of the software program. According to another embodiment the method further comprises an act of relating the software component to a database element of the software program using a unique identifier that identifies the software component.

According to one embodiment, the software program is executed by a mobile computing system. According to another embodiment, the software component includes at least one of a group comprising at least one software program and one or more related data files. According to another embodiment, the method further comprises an act of identifying one or more elements of the software program. According to another embodiment, the act of identifying elements of the software program further comprises an act of uniquely identifying the one or more elements of the software program. According to another embodiment, the act of identifying further comprises an act of uniquely identifying one or more elements of the software component within the distributed computing system.

According to one embodiment of the present invention, the method further comprises an act of downloading, to the mobile computing system, the software component. According to another embodiment, the act of downloading is performed in response to an occurrence of a contextual event. According to another embodiment, the method further comprises an act of synchronizing the software component among a distributed database storing at least two instances of the software component. According to another embodiment, the at least two instances are located among a plurality of computer systems. According to another embodiment, the act of synchronizing further comprises an act of determining a difference between two or more instances of said distributed database. According to another embodiment, the method further comprises an act of copying a software component associated with a first instance of said distributed database to a second instance of said distributed database. According to another embodiment, the software component is a plug-in application. According to another embodiment, the act of synchronizing further comprises an act of comparing at least one dependency of a software component stored in a first instance of the distributed database and at least one dependency of a software component stored in a second instance of the distributed database.

According to one embodiment of the present invention, the software component has an associated version number, and wherein the act of synchronizing further comprises an act of comparing a version number of a software component stored in a first instance of the distributed database with a version of a software component stored in a second instance of the distributed database. According to another embodiment of the invention, the method further comprises an act of invoking the software component. According to another embodiment, the act of invoking the software component further comprises an act of invoking the software component based at least in part on information associating the software component with the software program. According to another embodiment the method further comprises an act of determining a validity of the software component prior to performing the act of invoking the software component. According to another embodiment, the method further comprises an act of determining a signature of the software component prior to performing the act of invoking the software component.

According to one embodiment of the invention, the method further comprises an act of associating the software component with a synchronization process. According to another embodiment, the method further comprises an act of controlling, by the software component, the synchronization process. According to another embodiment, the method further comprises an act of determining, by the software component, whether to synchronize at least one instance of the distributed database. According to another embodiment, the method further comprises an act of determining, by the software component, a portion of the at least one instance of the distributed database to be synchronized. According to another embodiment, the method further comprises an act of determining, by the software component, when the at least one instance of the distributed database is to be synchronized.

According to one embodiment, the method further comprises an act of controlling the act of synchronizing the software component among a distributed database storing at least two instances of the software component. According to another embodiment, the method further comprises an act of resolving, by the software component, a conflict associated with the act of synchronizing. According to another embodiment, the method further comprises an act of mapping a schema element of the software component with a schema element of the distributed database. According to another embodiment, the method further comprises an act of mapping a plurality of field names associated with the software component and corresponding fields of the distributed database. According to another embodiment, the first instance of the distributed database and the second instance of the distributed database are located, respectively, on a client and a server. According to another embodiment, the first instance of the distributed database and the second instance of the distributed database are located, respectively, on a first peer computer system and a second peer computer system.

According to one aspect of the present invention, a system for synchronizing a plug-in application is provided. The system comprises a synchronization system including a distributed database configured to store plug-in applications and a schema for said database, said distributed database having at least two instances, a plug-in application stored in at least one instance of said distributed database, and said synchronization system being configured to synchronize said plug-in application between said at least two instances of said distributed database. According to one embodiment of the invention, said synchronization system is configured to perform a synchronization of said at least two instances of said distributed database, said synchronization based at least in part on the difference between two or more instances of said distributed database. According to another embodiment, said synchronization system is configured to copy a plug-in application for a first instance to said database to a second instance of said database. According to another embodiment, synchronization is based at least in part of a comparison of the differences between a plug-in application stored in a first instance of said distributed database with a plug-in application stored in a second instance of said distributed database.

According to one embodiment, synchronization is based at least in part of a comparison of at least one dependency of a plug-in application stored in a first instance of said distributed database at least one dependency of a plug-in application stored in a second instance of said distributed database. According to another embodiment of the invention, said plug-in application has a version number, and said synchronization is based at least in part of a comparison of the version of a plug-in application stored in a first instance of said distributed database with the version of a plug-in application stored in a second instance of said distributed database. According to another embodiment, the system further comprises a device configured to operate said plug-in application and wherein said synchronization is based at least in part on device-specific information. According to another embodiment, said device-specific information is the device type.

According to another aspect of the present invention, a system for deploying a plug-in application is provided. The system comprises a synchronization system including a distributed database configured to store plug-in applications, information associating said plug-in application with at least one application, and a schema for said database, said distributed database having at least two instances, a plug-in application stored in at least one instance of said distributed database, and an extension manager configured to invoke said plug-in application, said synchronization system being configured to synchronize said plug-in application between said at least two instances of said distributed database. According to another embodiment, said extension manager is configured to invoke said plug-in application based at least in part on said information associating said plug-in application with said at least one application. According to another embodiment, said extension manager is configured to determine the validity of a signature associated with said plug-in application prior to said invocation. According to another embodiment, said plug-in application is associated with a synchronization process. According to another embodiment, said synchronization is controlled at least in part by said plug-in application.

According to one embodiment of the invention, said plug-in application determines whether to synchronize said at least one instance of said distributed database. According to another embodiment said plug-in application determines the portion of said at least one instance of said distributed database to synchronize. According to another embodiment, said plug-in application determines when to synchronize said at least one instance of said distributed database. According to another embodiment, said synchronization is controlled entirely by said plug-in application. According to another embodiment, said plug-in application is configured to resolve conflicts in said synchronization. According to another embodiment, said plug-in application is configured to provide at least one mapping between the plug-in application's schema and said schema for said database.

According to one embodiment of the invention, said mapping includes a mapping between field names in said plug-in application and fields in said synchronized database. According to another embodiment, said mapping includes the creation of a new synchronized field in accordance with at least one aspect of said plug-in application. According to another embodiment, said mapping includes reconciling at least one field between at least two different versions of said plug-in application. According to another embodiment, said plug-in application is associated with a deployed application. According to another embodiment, the system further comprises an indentification component adapted to uniquely identify the plug-in application stored in the at least one instance of said distributed database. According to another embodiment, the system further comprises an identification component for uniquely identifying the the plug-in application stored in the at least one instance of said distributed database, wherein the plug-in application is accessed using the identification component. According to another embodiment, said at least two instances of said distributed database are located, respectively, on a client and a server. According to another embodiment, at least two instances of said distributed database are located, respectively, on a first peer computer system and a second peer computer system.

Further features and advantages of the present invention as well as the structure and operation of various embodiments of the present invention are described in detail below with reference to the accompanying drawings. In the drawings, like reference numerals indicate like or functionally similar elements.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows an illustration of a synchronization system that may be used to implement various aspects of the present invention;

FIG. 2 shows an example architecture including a synchronization system with extension manager and plug-ins;

FIG. 3 details an example embodiment of an Extension Manager, and its communications with at least one plug-in; and

FIGS. 4a-4h illustrate example management user interfaces for entering, registering, and establishing associations for plug-ins.

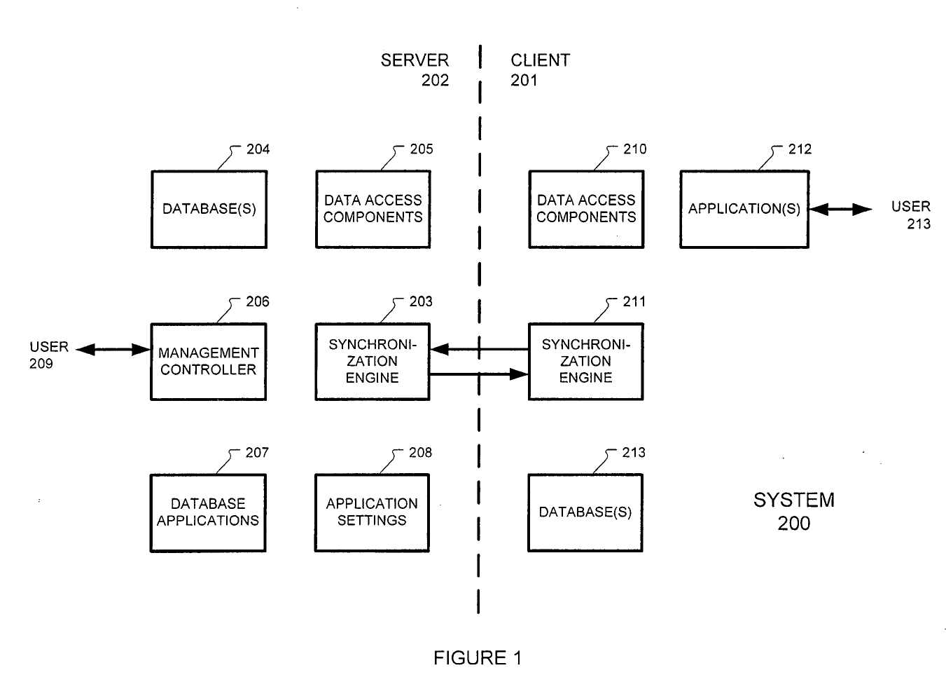

### DETAILED DESCRIPTION

The following examples illustrate certain aspects of the present invention. It should be appreciated that although these examples are provided to illustrate certain aspects of the present invention, the invention is not limited to the examples shown. Further, it should be appreciated that one or more aspects may be implemented independent from any other aspect. This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

Various aspects of the present invention relate to synchronization systems that are effective to operate in a distributed environment. Generally, a system is distributed of the data, software, and hardware needed for a particular system are instantiated across several locations (e.g., in a network) but appear to the user as if they were united. One aspect of the synchronization systems according to various embodiments of the invention is their ability to support a multitude of distributed devices, users, and/or synchronization system-based applications creating, updating or deleting records concurrently across multiple instances of a particular database. In one embodiment, the synchronization system is implemented as a loosely coupled, distributed data, services oriented architecture (SOA).

In a distributed synchronization system, it is appreciated that some of the key aspects for a reliable, scalable solution include the ability to eliminate remote dependencies for performance reasons. When deployed using a synchronization system, it is appreciated that an application's performance can be dramatically improved if the device uses the local processing power for constructing a user interface versus having to deliver user interface elements over a network regardless of bandwidth. This is especially true in a mobile environment where no Internet connection may be available. In this situation, the local device depending on the server to construct the user interface would not be able to fully or partially execute an application that relies on synchronization to operate. One such application, referred to herein as a synchronization system-based application, involves a business application that uses a synchronization system to synchronize program, data, and user interface components. For a synchronization system-based application to operate in a self-sufficient manner, the system needs to have available to it all resources, which, in addition to the data, the user interface, and code, also includes roles, permissions, access control rights, etc. (collectively, “components”). One such synchronization system provides distributed application and data synchronization.

According to one embodiment, the synchronization system further provides an extension mechanism providing for distribution of synchronization system-based applications and synchronization system-based application extensions and their associated resources and components (hereinafter “plug-in applications” or “plug-ins”), such that any synchronization system-based application instantiation may be changed or updated by the synchronization system. In one specific example using the synchronization system, each synchronization system-based application or plug-in is self-contained and self-updateable through a synchronization system synchronization process. A further benefit is that the synchronization system and synchronization system-based applications may be extended independent of device type or operating system.

Thus, in one aspect, the present invention provides a system for synchronizing one or more plug-in applications. In one embodiment, the system for synchronizing plug-in applications comprises a synchronization system including at least one distributed database that is configured to store a plug-in application, and a schema for the database. Optionally, the distributed database may be configured to store plug-in application instantiation information, synchronization system-based application association information, role, permissions, access control rights, and data associated with the plug-in application. Each distributed database has at least two instances, and the plug-in application (and optional resources and components) is stored in at least one instance of the distributed database. As described herein, the synchronization system is configured to synchronize the plug-in application (and optional resources and components) between the instances of said distributed database.

The synchronization system typically includes a synchronization manager, at least one distributed database, and at least one distributed application. The synchronization system provides a loosely coupled, distributed application environment upon which aspects of the present invention builds. One suitable synchronization system that may be used in accordance with various aspects of the present invention is described in U.S. application Ser. No. 11/229,486, filed Sep. 15, 2005, entitled “SYSTEM AND METHOD FOR MANAGING DATA IN A DISTRIBUTED COMPUTER SYSTEM”, and U.S. application Ser. No. 11/229,311, filed Sep. 15, 2005, entitled “SYSTEM AND METHOD FOR MANAGING DATA IN A DISTRIBUTED COMPUTER SYSTEM”, both of which applications and their parent applications are incorporated herein by reference by their entirety and for all purposes.

Suitable distributed databases include, for example, commercial databases such as MySQL, SQL*Server, Sybase SQLAnywhere (without limitation), including implementations such as those described in the above referenced patent applications, and available commercially from Adesso Systems, Boston Mass. The schema describes elements stored within each distributed database, and may include descriptions of application and plug-in components. Each of these elements just described can be implemented by those having ordinary skill in the art. According to one embodiment, plug-ins stored in instances of the distributed database may be associated with one or more applications of the synchronization system that are also stored in a same or different distributed database. An example of one such plug-in can be found in the plug-in example further below. Each of these elements described above can be implemented by those having ordinary skill in the art.

In another embodiment of the synchronization system just described, the synchronization system may be configured to perform a synchronization of at least two instances of the distributed database. In a more specific embodiment, the synchronization is based at least in part on a difference between two or more instances of the distributed database. In one, more specific, embodiment, the synchronization is based at least in part of a comparison of the differences between a plug-in application (and/or optional resources and components) stored in a first instance of the distributed database with a plug-in application stored in a second instance of the distributed database. In another embodiment, the synchronization is based at least in part of a comparison of at least one dependency of a plug-in application (and/or optional resources and components) stored in a first instance of the distributed database at least one dependency of a plug-in application (and/or optional resources and components) stored in a second instance of the distributed database. In still another embodiment, a plug-in application (and/or optional resources and components) has a version identifier, and the synchronization is based at least in part on a comparison of the version identifier of a plug-in application (and/or optional resources and components) stored in a first instance of said distributed database with the version identifier of a plug-in application (and/or optional resources and components) stored in a second instance of said distributed database. One example of a suitable version identifier is a version number. However, it should be appreciated that other suitable version identifiers may be used that identify a particular plug-in application that may be apparent to those having ordinary skill in the art. Further, a determination of such differences between versions of a plug-in application can be implemented by those having ordinary skill in the art. In another embodiment of the invention, in addition to performing any of the above-described difference-based synchronizations, the synchronization system also copies a plug-in application (and/or optional resources and components) for a first instance to said database to a second instance of said database.

In other embodiments of the invention, each of the aforementioned synchronization systems further comprise a device configured to operate the plug-in application, and the synchronization is based at least in part on device-specific information. In more specific embodiments, the device-specific information is the device type. Examples of such devices and device types include specific instances of devices such as identified by name, device ID, MAC address, or IP address, and manufacturer specific devices such as Nokia cellular telephones, Palm PDAs, and Microsoft Pocket PC-based devices, among others. Implementation of operations for determining device IDs and device types are familiar to those having ordinary skill in the art.

In still other embodiments of the invention, the plug-in application is configured to provide at least one mapping between the plug-in application's schema and said schema for said database in addition to the elements of the various embodiments of the synchronization system of the invention described above. Examples of such mappings include a mapping between field names in the plug-in application and corresponding fields in the synchronized database, creation of a new synchronized field in accordance with at least one aspect of the plug-in application, and reconciling at least one field between at least two different versions of the plug-in application.

In another aspect of the present invention, a system for deploying a plug-in application is provided. In one embodiment, the system for deploying a plug-in comprises a synchronization system including a distributed database configured to store plug-in applications, information associating said plug-in application with at least one application, and a schema for said database. The distributed database has at least two instances, and a plug-in application is stored in at least one instance of the distributed database. In one embodiment, an extension manager is provided that is configured to invoke said plug-in application, and the synchronization system is configured to synchronize the plug-in application between the instances of the distributed database. Furthermore, an association or configuration between at least one synchronization system-based application and a plug-in may be stored in the synchronized database, is synchronized between instances of the database by the synchronization system, and is used by the extension manager to dispatch and/or configure calls to the application plug-in. The association and configuration aspects of the materials stored in the synchronized database may include any of the components of a plug-in application, as described herein.

In one embodiment of a system for deploying a plug-in application consistent with principles of the present invention, the plug-in application is associated with a deployed application. Such associations will be familiar to those having ordinary skill in the art, such as the use of plug-ins associated with the Microsoft Outlook application program. One embodiment of the present invention includes deploying a plug-in application (and/or optional resources and components) using the synchronization mechanism, is integrated with loosely coupled, distributed applications already distributed by the synchronization system, and provides invocation and dispatch to the plug-in application using the extension manager.

In a more specific embodiment of the above-described system for deploying a plug-in application, the extension manager is configured to invoke the plug-in application. In more specific embodiments, such invocation is based at least in part on the information associating the plug-in application with at least one application. Examples of suitable information include association of the plug-in application with at least one event of a synchronization system-based application, a GUID identifier of the plug-in application, and invocation parameters. In a still more specific embodiment, the extension manager is further configured to determine the validity of a signature associated with said plug-in application prior to said invocation. Suitable signatures include those produced by public key-based algorithms such as MD5 or SHA-1. The provision and determination of such signatures will be familiar to those having ordinary skill in the art.

In other embodiments of the above-described system for deploying a plug-in application, the plug-in is associated with the synchronization process (i.e., the plug-in decision component described herein). In some embodiments, such association includes controlling the synchronization at least in part using the plug-in application. For example, the plug-in application can be called during the synchronization process to indicate whether specific records should be synchronized. Alternatively, the plug-in application may be called during synchronization to help resolve specific conflicts encountered during synchronization. In still other example embodiments, the plug-in application may be called to perform the communication with an external system or service. In other embodiments, the association includes using the plug-in application to determine whether to synchronize an instance of the distributed database. In yet other embodiments, the association includes using a plug-in application to determine the portion of an instance of the distributed database to synchronize. In still other embodiments, the association includes using a plug-in application to determine when to synchronize an instance of the distributed database. In other embodiments, the association includes using a plug-in application to control substantially all aspects of the synchronization of an instance of the distributed database, or control completely the synchronization of an instance of the distributed database. In still other embodiments, the association includes using the plug-in to resolve conflicts in said synchronization.

According to one embodiment, the synchronization system provides a GUID-based mechanism for synchronization of distributed databases and synchronization system-based applications. This aspect overcomes the limitations inherent within relational database systems to identify a record other than by its contents or rowid. By using an abstracted GUID layer, the synchronization system can uniquely identify specific records, any changes to each record, and use this information for the purposes including synchronizing two or more database instances. Similarly, by tracking schemas and synchronization system-based applications within a distributed database, changes to schemas and synchronization system-based applications may be similarly managed. This ability to track individual change across various instances of the data allows the synchronization process to be streamlined, only having to update/add/delete records, fields, tables, etc. that have been changed since the last synchronization. One aspect of the present invention includes the ability to leverage high-level SQL statements against the local and remote instances of a distributed database in order to identify the portions of each distributed database to be synchronized. The high-level SQL statements may be statically or dynamically constructed, and may be constructed in whole or in part by a plug-in consistent with principles of the present invention. A distributed data model leverages a synchronization process that, unlike other database synchronization methods, is not trying to make two or more databases consistent.

Rather, synchronization involves distributing the relevant data and synchronization system-based application components such that the instantiation of the synchronization system-based application on that particular device, at that moment, is consistent with what the business or consumer solution requires, with the appropriate level of data and transactional integrity.

The synchronization system provides a set of synchronization events during the synchronization process that may be serviced by the extension manager and passed on to at least one plug-in. These synchronization events may be provided at various points in the synchronization process, and may be provided once per distributed database, or once per GUID-based item in each distributed database. The provision of such events permits any synchronization system-based application (or application extension) to service the event, and thus interact and control the synchronization of one or more distributed database elements.

In one example implementation, the synchronization system uses a set of web services interfaces to allow one way or bi-directional synchronization between distributed devices and/or at least server system. Synchronization settings according to various embodiments can be configured by table, record, or even field level and by user, user group, device, or any other data or variables available during synchronization, including the synchronization system-based application data itself. In this manner, current data in a particular record or field can be used to determine whether or not data should be transferred or exchanged between devices or systems. Any data, whether it is within a synchronization system-based application or external to the synchronization system-based application, including being housed in another table, another database, and/or another system altogether, can be used as input to the synchronization logic. For example, a dynamic constraint could be configured by determining data flow based on a particular device type used during synchronization in conjunction with the value of a particular field. For example, if a user were synchronizing their synchronization system-based application residing on a mobile phone, based on this device type, the system might not transfer any files larger than 10 KB, and would only send data records down that were categorized as open as indicated by the status field.

Because the synchronization settings, and/or configuration, are used, in part, to determine the flow of data (synchronization system-based application data, synchronization system-based application schema data, or synchronization system-based application components including plug-ins) between devices and/or servers, plug-in distribution also benefits from this dynamic synchronization process. Continuing the above example, it would be possible to transfer the plug-in components only to devices with a specific operating system version or other prerequisite dependency. In this manner, the system can determine which plug-in should be distributed to which device based on permissions, device type, related resource dependencies, and also determine what resources associated with the plug-in should be distributed. For instance, a plug-in could provide an alternative user interface for a particular function within the synchronization system-based application. If the plug-in were distributed to a PocketPC device, then one set of graphical user interface files would be sent—those that are customized for that particular device screen resolution. However, if the same plug-in, or a different one, were distributed to another device, then a different graphical UI file would be sent to that device. In this manner, not only is the plug-in distribution effective for managing related resource files, but it also help manages bandwidth, storage and overall system performance by not having to manage unnecessary resources.

In addition, aspects of a plug-in may be used to make at least an aspect of the decision as to whether specific information is synchronized to a specific device. The plug-in may provide program logic, attributes, or data to contribute to this decision.

In an alternate embodiment, synchronization may be governed by “synchronization rules.” These rules describe algorithmic methods for governing the synchronization process. In one particular embodiment, synchronization rules are constructed and executed through the use of Structured Query Language (SQL). SQL is used to query the synchronization system, any related databases and/or tables, and can also be used to create very simple to very complex conditional queries. The query can include any number of compute and compare functions using any data set available to the synchronization system, internally or externally, as well as parameterized information that is provided by the synchronization system. This parameterized information can include information about users (such as user name, email address, etc.) or device type, IP address, connection speed, time, access point, permissions, roles, access control rights, and many other system parameters. In this manner, it is possible to construct synchronization rules that are constant or dynamic in nature, or that include elements of both.

Plug-ins

A synchronization system form is a collection of objects, properties, attributes, images, and application components that are stored in a distributed database of the synchronization system. Collectively, a form is interpreted by the synchronization system forms engine (not shown) that responds to form management events to provide a user interface. Synchronization system applications leverage this technology to produce a synchronizable user interface across devices. The plug-in technology further leverages this technology to provide additional functionality to synchronization system forms.

The synchronization system plug-in architecture provides the ability for third party synchronization system-based applications (and extensions to the synchronization system itself) to interact with the synchronization system to support synchronization between synchronization system-based applications deployed on disparate devices and one or more common data sources and to provide extensions to these synchronization system-based applications. Each synchronization system-based application may be associated with one or more additional components that are associated with at least one synchronization system-based application by an Extension Manager of the synchronization system. These components support the synchronization and/or extension of synchronization system-based application specific information, including information about the synchronization system-based application itself, the synchronization system-based application's data, and other materials. A logical set of of these extension components is called a “Plug-in.”

Each plug-in can be associated with all necessary additional resources (e.g., files, databases, programs, permissions, roles) that it might require to function correctly. These dependencies may be associated, for example, using entries in a GUID-based distributed database associated with the synchronization system. According to one embodiment, these entries may be similar to entries made for applications of the synchronization system, and are synchronized with the client in the same manner as applications of the synchronization system. Thus, a mechanism is provided that allows for complex processes involving multiple programs and/or data files to be integrated with one or more synchronization system-based application(s). Use of the synchronization system-based application synchronization method provides a mechanism that allows a synchronization system plug-in to be distributed seamlessly during a synchronization process. In essence, each plug-in can be considered part of one or more of the synchronization system's distributed synchronization system-based application(s), thereby integrating multiple external, heterogeneous synchronization system-based applications (and extensions) into a single synchronization workflow. Each synchronization system plug-in may be associated with one or more synchronization system-based application design elements, including expressions, button-pressing events, record open/new events, data validation, and form navigation elements.

By selecting a few configuration parameters relative to any event and type of plug-in, an event and plug-in may be associated with one another. According to one aspect of the present invention, no code needs to be written in order to use a plug-in within a synchronization system-based application. By using a point and click, property selection dialogue process, a plug-in can be configured to work with any synchronization system-based application and on any platform, if it has been written appropriately to do so, meaning that the person or system configuring the plug-in understands the data the plug-in is expecting, similar to a contract. These same parameters also can be used within the synchronization process to determine what, if any, plug-ins or related resources are needed for the synchronization system-based application to be self-sufficient. If a device needs a specific form to display a certain set of data, and a plug-in is being used to display the data, then the synchronization process checks the configuration of the synchronization system-based application and assures distribution of any plug-ins and related resources to the appropriate devices.

Plug-ins and their related components (including associations) may be stored within one or more distributed database(s) of the synchronization system. Plug-ins and their components that can be stored may include, for example, the plug-in synchronization system-based application, the synchronization system-based application data, the synchronization system-based application schema, and any related components. In addition to the plug-in synchronization system-based application components, tables, fields, and other synchronization system-based application schema components (such as the table relationship definitions, forms, views, filters, synchronization rules, and permissions), all other synchronization system-based application attributes are stored as data within at least one distributed synchronization system-based application database. Related components may be referred to collectively as dependencies of the plug-in.

Examples of plug-in uses are as varied as synchronization system-based applications. For example, a plug-in can support activities such as performing a customized print job, interfacing with a Web Service, processes that involve verifying or collecting information for a synchronization system-based application, and other types of uses.

It should be appreciated that although plug-ins may be synchronized between a client and server, such synchronization methods may be used in a peer-to-peer communication such that plug-ins and their associated data may be synchronized among computer systems.

Any synchronization system-based application function within the synchronization system can be replaced, enhanced or extended. Additionally, new functions or features easily can be added through plug-in integration, or existing plug-in modification. In an example embodiment, a plug-in can be integrated with synchronization system-based applications by defining actions associated with form buttons, EXEC commands, and events exposed by the synchronization system-based applications. A plug-in also can be integrated as a metadata extractor associated with one or more file types. While these examples described herein exemplify how the synchronization system platform can integrate plug-ins with a synchronization system-based application, the list is not meant to be a closed or exhaustive one. More particularly, other methods for associating a plug-in with a synchronization system-based application may be used, and the invention is not limited to the specific examples described. Adding plug-in capability to synchronization system forms and views streamlines business processes and enhances the private user's experience by putting necessary functions onto a single form where they are needed. Thus, users are able to customize their synchronization system-based applications to best suit their needs and goals by integrating desired functionality into the synchronization system. According to one embodiment, integration of plug-ins is a dynamic process, meaning plug-in applications can be added, modified, deleted, and/or shared across synchronization system-based applications at any time.

According to one embodiment, an entity referred to herein as the Synchronization System Extension Manager manages each plug-in. Each plug-in further comprises one or more synchronization system-based application components. One of these components is referred to herein as a “handler.” A handler provides an interface by which an Extension Manager communicates with each plug-in.

According to one embodiment, the plug-in (handler) API supports the same platforms supported for synchronization system-based applications, preferably Windows and Pocket PC 2003. These platforms may be constructed using standard development frameworks, such as .NET version 1.1 and the Compact Framework version 1.0, both from Microsoft of Redmond, Wash. The extension manager and its components, and plug-in components and handler interfaces may be developed in any programming language. In some embodiments, these languages include C++, C#, or other .NET-compatible programming language. Alternative embodiments may support other platforms and programming languages, such as a Java-based platform hosted on Linux, or on embedded platforms such as Symbian or Windows CE. An example plug-in might be a .NET Assembly that interfaces to a Web Service for verifying or obtaining additional information for the synchronization system.

In one embodiment of the present invention, the synchronization system supports the .NET environment to facilitate the linkage of plug-ins with the synchronization system through XML data as the common denominator. When using the .NET environment, plug-ins can be written in any computer language and/or for any operating system, and still be quickly and successfully integrated with the synchronization system. Because, according to one embodiment, all information stored in the synchronization system is stored as XML data, including the plug-in linkage, multiple languages and/or operating systems can be successfully and easily integrated with the synchronization system.

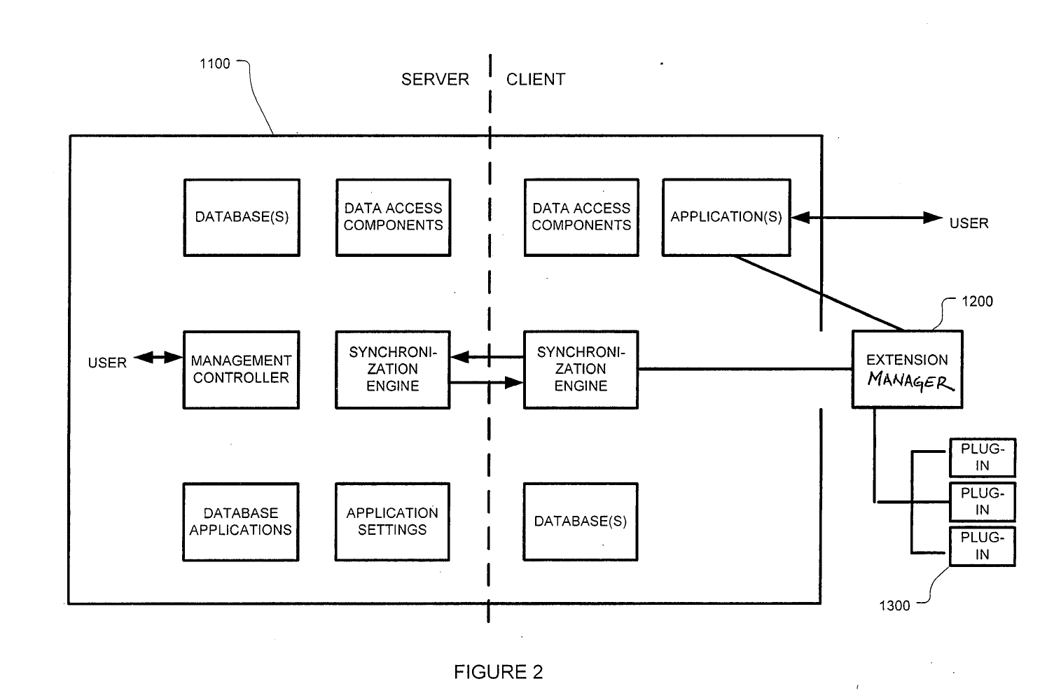

FIG. 2 illustrates an example architecture including an Extension Manager 1200 of the synchronization system 1100. Extension Manager 1200 operates on the synchronization system client and communicates with the synchronization system 1100 to send and receive events between Extension Manager 1200 and the synchronization system 1100. Extension Manager 1200 further communicates using various methods with one or more plug-ins 1300, which operate to manage at least an aspect of synchronization between a synchronization system client and at least one synchronization system server. Plug-ins and the Extension Manager architecture are discussed more fully below.

Extension Manager

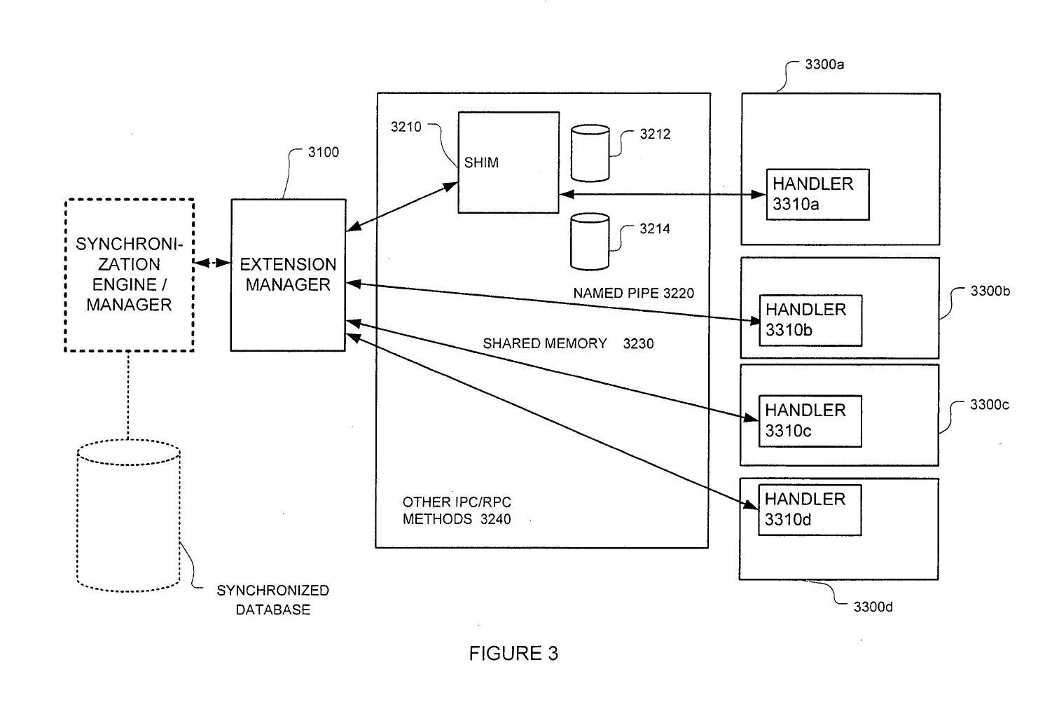

FIG. 3 details an example embodiment of an Extension Manager 3100, RPC/IPC communications methods (3200), the SHIM 3210, request and response files (3212 and 3214), named pipe (3220), shared memory (3230), and other RPC/IPC communication methods (3240), and an instance of a plug-in handler (3310a, 3310b, 3310c, 330d) associated with at least one plug-in (3300a, 3300b, 3300c, 3300d).

According to one embodiment, the Extension Manager operates to coordinate operation of plug-in components, including event management, registration of plug-ins, synchronization of synchronization system-based application data, and interaction between the synchronization system and various plug-ins. The following outlines example functional responsibilities of the

Extension Manager:

Providing Event Management between the synchronization system and plug-ins.
Providing interfaces for business logic.
Containing any and all common code that any piece of business logic needs to interface to (e.g., XML generation code).
Signaling Execute and Exit windows commands to a SHIM running in another process.
Starting up the SHIM.
Starting and stopping the CLR if and when hosting of a CLR in a Microsoft programming environment is needed.
Providing an XML parser and interface for obtaining results.
   Event Management

The Extension Manager, upon initialization, registers to receive synchronization system events. The following synchronization system events trigger an Extension Manager operation:
Field Selection calculations—Custom Expression EXEC Command executes, and a value is returned to the Expression. Expression may be used in Form Validation.
Form events, including Form Save, Form Load, and Form Button—OnButtonClick or Tap.
Custom Alternate Form-editor UI—On form open. Launching and interacting with a third party forms-editor.

Additionally, the Extension Manager can register for synchronization events such “Start of Synchronization,” “End of Synchronization,” “Select Rowset,” “Synchronize Element,” and “Conflict Element.”. The complete set of synchronization events may be a subject of the synchronization application distributed with the synchronization system.

Business Logic

Business logic is defined to be some section of code in the synchronization system Client that has associated with it a design element that in turn is associated with a registered Handler. These design elements could include, for example, field expressions, forms, or form buttons. When an event occurs on a given design element and a Handler is associated with that element, the business logic may perform the following:
1. Interface with the synchronization system Database and generate an XML Fragment File.
2. Create and load a context block containing a pointer to the Handler BLOB, Assembly Name, Class Name, and any Handler specific properties. The Handler may already exist in sotrage, and the MD5 Hash and Extension Manager Handler Cache can be utilized to skip the re-instantiation of it.
3. Calls the Dispatch method of the Extension Manager providing a reference to the context block.
4. Wait for a response (for the configuration defined length of time). If there is no response, terminate the handler and return an error XML response file.
5. Processes the XML response file. This could be part of Expression processing, database updates, Re-calc processing, etc.
6. If further handshakes are required, depending on the Handler Type and last XML response, go to Step 1 and continue.
   Handler Interface

The Handler interface is an abstract interface defined by the synchronization system that the third party plug-in implements. In exemplary embodiment of a .NET version of the present invention, the IExpressionHandler Interface is defined in AdessoExpressionHandler.dll, a strong name signed assembly that is produced and shipped by Adesso Systems of Boston, Mass. An implementation of an ExpressionHandler implements the IExpressionHandler interface. Preferably, the exemplary .NET embodiment of the present invention is also implemented as a “Smart Device Class Library” project, which enables the Class file and its implementation to be executed on both the .NET Compact Framework as well as the Full Framework. In one embodiment of this invention, Plug-ins can run in the .DLL format, and .NET Assemblies can be signed and strongly named.

An example public interface to the exemplary .NET IExpressionHandler is shown below:

public interface IExpressionHandler
{
String Handler(string xmlFragment);
System.Xml.XmlDocument Handler(System.Xml.XmlDocument
xmlFragment);
}

The distributed database schema for at least one distributed database is extended to support handler information. A Handler Object Type is added to each synchronization system database schema which supports plug-ins. Properties of the Handler Object include:
Qualified Name—Plug-in File Name.
Class Name—Assembly Type or Java class Name.
Handler Type—An enumerated type representing the type of Handler (i.e. EXEC Expression, Form Save, Form Load, Form Button, Form UI).
Size—The on disk size of the Assembly or Java class/jar.
Field Filter—Variable argument list of fields to include in XML. NULL means all fields.
MD5 Hash—used for determining if disk refreshes of Handler required.
Handler Binary Data
   IPC/RPC Between Extension Manager and Plug-Ins

The architecture supports a plurality of communications methods for the Extension Manager to communicate with plug-ins. Different implementation platforms support various communications mechanisms, including IPC, RPC, messaging, including stateful and stateless approaches—the selection of a specific communication method is implementation dependent. Alternatively, a plug-in may be constructed to support a plurality of communications methods, and the selection of communications methods to use may be left to the Extension Manager and SHIM components.

In a first example embodiment, a file-based SHIM approach is employed for inter-process communications. In one example implementation, all Handler Request and Response operations are done synchronously. The Extension Manager communicates with a SHIM 3210, which functions as a request mediator and context switch component. In one example embodiment, the Extension Manager contacts the SHIM Mediator for a request/response synchronous operation wherein the Extension Manager first creates an XML request file. This XML file directs the SHIM process to take the file and route the file to the appropriate plug-in on the basis of the associations stored in the distributed database. If the plug-in is not started, the Extension Manager or SHIM starts the plug-in by loading it from the distributed database. In some embodiments, the plug-in application is checked for integrity by validating a digital signature associated with the plug-in. Once contacted, the plug-in accepts the XML request information, runs, and returns its results back to the SHIM. At this point the SHIM process creates a response XML file, and then returns control back to the Extension Manager. Results are validated and then provided to the synchronization system-based application, where they may be used in a form, calculation, or other process step. One example XML file structure is described below.

In another example embodiment, named pipes are used in place of the SHIM process. In yet another example embodiment, the SHIM process is replaced with the use of read/write shared-memory calls. Other embodiments utilizing well-known inter-process communication/remote procedure call techniques such as CORBA, JINI, or RPC are also possible. In some embodiments, the named pipes, shared memory, or other IPC/RPC mechanisms are used to communicate an XML structure comparable to the XML structure in the XML request/response files described above. Alternatively, the Extension Manager may marshal the request to alternate in-memory structures appropriate for the IPC method selected to communicate between the Extension Manager and the instance of the plug-in.

A plurality of plug-ins may be supported simultaneously using each individual inter-process communication mechanism. Note that the use of RPC/IPC mechanisms do not require specific plug-ins to be executed on the same device as the application, as long as the RPC/IPC mechanism is available and connected. Additional example embodiments are further envisioned that simultaneously utilize a plurality of communication mechanisms, including the SHIM process, the named pipes mechanism, the shared memory techniques, or other IPC/RPC techniques to simultaneously support multiple requests for plug-in execution.

XML messages (fragments) are preferably used for requests to Handlers and for resulting responses back from them. As described above, an IPC method such as the file-based SHIM inter-process communications mechanism may be used. The contents of XML the message is dependent on the type of Handler for which the message is destined.

Consider the following XML message:

<EventHandler Type=″Form Button″>
<Form Name=″UserInput″ ID=″{guid}″>

```
<Tab Name=″Tab1″ Enabled=″1″ Visible=″1″>
  <Field Name=″Field1″ Enabled=″1” Visible=″1”>Value1</Field>
  <Field Name=″Field2″ Enabled=″1″ Visible=″1″>Value2</Field>
</Tab>
```

</Form>
</EventHandler>

According to one embodiment, the above fragment may be passed as a parameter to the event handler. The event handler is free to do whatever processing the handler deems appropriate. In order to return results to the Extension Manager, the called Handler transforms the XML and returns the transformed XML.

For example, to disable the second field on the form the Handler would return the following XML fragment:

<EventHandler Type=″Form Button″
Assembly=C:\Documents and Settings\mpalone\My
Documents\My Adesso Synchronization system
applications\handlers\AdessoEventHandler.dll
Class=Adesso.Client.CosineHandler>
<Form Name=″UserInput″ ID=″{guid}″>

```
<Tab Name=″Tab1″>
  <Field Name=″Field1″ Enabled=″1″ Visible=″1″>Value1</Field>
  <Field Name=″Field2″ Enabled=″0” Visible=″1″>Value2</Field>
</Tab>
```

</Form>
</EventHandler>

For example, to return a different value for a field, the handler would return the following XML fragment:

<EventHandler Type=″Form Button″
Assembly=C:\Documents and Settings\mpalone\My
Documents\My Adesso Synchronization system
applications\handlers\AdessoEventHandler.dll
Class=Adesso.Client.CosineHandler>
<Form Name=″UserInput” ID=″{guid}”>

<Tab Name=″Tab1” Enabled=″1” Visible=″1”>
<Field Name=″Field1” Enabled=″1” Visible=″1” >New

Value</Field>

<Field Name=″Field2” Enabled=″1” Visible=″1”/>Value2</Field>
</Tab>

</Form>
</EventHandler>

Sample XML Fragment for Expression Return Value:

<Result ResultType=″Text”>Value1</Result>

Sample XML Response Fragment for Error Return Value:

<Error>Error Text</Error>

Similarly, a plug-in may be called with one or more data elements or database records for processing by the plug-in. The example XML below illustrates the XML that might be used to send information about several distributed database rows to a plug-in. The plug-in may use the data in a form, for synchronization decisions, or for other purposes. Note that the XML shown below illustrates the sending of more than one database record to a form.

<FormField Name=“” ID=“77” Type=“OneToMany” ControlType=“OneToMany”
TableName=“” Enabled=“1” Visible=“1” bgcolor=“#00ffffff”
textcolor=“#00333333” robgcolor=“#00e8e3da” rotextcolor=“#00333333”
fontsize=“8” bold=“0”>

<FieldPos xpos=“1” ypos=“544” width=“225” height=“85” />

<Label Name=“OneToMany” ID=“77” bgcolor=“#00ffffff”
textcolor=“#00333333” align=“left” fontsize=“8” bold=“0”>

<LabelPos xpos=“1” ypos=“544” width=“225” height=“85” />

| | </Label> |
|---|---|
| − | <Records TableName=“Deposit” TableGUID=“{EF3D8134-1503-48D2-B4B6- |

27020CC46776}”>

| − | <Record GUID=“{58215A32-0EC3-461A-A8DF-B19048894FEB}”> |
|---|---|
| | <Field Name=“DepositID” |

DataType=“Text”>58215A320EC3461AA8DFB19048894FEB</Field>

<Field Name=“SessionID”

DataType=“Text”>4D159AF026464155B72962FB2854EABA</Field>

<Field Name=“AccountNumber” DataType=“Text”>53626352234</Field>
<Field Name=“CheckAmount” DataType=“Integer”>$ 200.00</Field>
<Field Name=“RoutingTransitNumber” DataType=“Text”>232468932</Field>
<Field Name=“ACHImage” DataType=“Binary” />
<Field Name=“CheckImage” DataType=“Binary” />
<Field Name=“RoutingTransitNumberCheck”

DataType=“Integer”>232468932</Field>

| | </Record> |
|---|---|
| − | <Record GUID=“{71562039-43D5-43E4-9298-223D0615FCAC}”> |
| | <Field Name=“DepositID” |

DataType=“Text”>7156203943D543E49298223D0615FCAC</Field>

<Field Name=“SessionID”

DataType=“Text”>4D159AF026464155B72962FB2854EABA</Field>

<Field Name=“AcoountNumber” DataType=“Text”>03425098345</Field>
<Field Name=“CheckAmount” DataType=“Integer”>$ 9,000.00</Field>
<Field Name=“RoutingTransitNumber” DataType=“Text”>056925689</Field>
<Field Name=“ACHImage” DataType=“Binary” />
<Field Name=“CheckImage” DataType=“Binary” />
<Field Name=“RoutingTransitNumberCheck”

DataType=“Integer”>56925689</Field>

| | </Record> |
|---|---|
| − | <Record GUID=“{D6F202DF-B78D-4A58-8809-9833C44F0ADE}”> |
| | <Field Name=“DepositID” |

DataType=“Text”>D6F202DFB78D4A5888099833C44F0ADE</Field>

<Field Name=“SessionID”

DataType=“Text”>4D159AF026464155B72962FB2854EABA</Field>

<Field Name=“AccountNumber” DataType=“Text”>324623573457</Field>
<Field Name=“CheckAmount” DataType=“Integer”>$ 4,000.00</Field>
<Field Name=“RoutingTransitNumber” DataType=“Text”>435678329</Field>
<Field Name=“ACHImage” DataType=“Binary” />
<Field Name=“CheckImage” DataType=“Binary” />
<Field Name=“RoutingTransitNumberCheck”

DataType=“Integer”>435678329</Field>

</Record>
</Records>
</FormField>

An example implementation of a synchronization system plug-in is created as a .NET assembly. When implemented as .NET assemblies, it is recommended that these assemblies be implemented as Smart Device Synchronization system-based applications or Class Library projects to support the Pocket PC platform as well as Windows. Plug-ins may be associated with the following synchronization system client constructs.
Expressions and functions
EXEC command
Form Buttons—Used for triggering external processes, custom printing, interactions with Web Services, etc.
Events
Metadata Extractors
   Expressions and Functions

In one embodiment of this aspect of the invention, the extension manager may invoke specific functions or expressions that can be programmed into a synchronization system-based application to extend the synchronization system's currently defined expression language commands. Expressions are a combination of identifiers, values, and/or operators that yield a result upon evaluation. For example, a simple function may be set up to calculate the square root or cosine of a number. However, functions do not need to be simple; the resulting value of a function then can be assigned to a variable, passed as an argument, tested in a control statement, and/or used in another expression before the plug-in is finished executing. Functions also can be programmed to call other programs, whereby each iteration is working with the dynamic result set of the previous plug-in execution. Expression functions also can be used to do field selection calculations, validation expressions, etc. Expression functions powerfully extend the synchronization system by allowing users to identify custom configurable events.

In one embodiment of a function, a developer can create program code to dynamically check for certain conditions, and in response to whether the conditions have been met, then trigger a particular course of action. For example, a user may set up a function to check to see when the sales for a particular quarter reach a $250,000 goal. If the goal is met at a particular point, then action X may happen (send an email to the district manager to notify her of the success and notify accounts payable to send bonus checks out to appropriate parties); if the goal is not met, then action Y may happen (send an email to the sales team to redouble their efforts in the field). Through this functionality, developers can create their own custom business logic based on dynamically passed parameters, using internally or externally generated data/information from the synchronization system.

In other embodiments of a function, a developer can create program code to make decisions related to the synchronization of one or more data or program elements within a synchronized database. The program code may take information about the operating environment, including user, user profile, device, and application attributes, as well as database specific information such as schema, table, GUIDs, and data values and use this information to make aspects of synchronization decisions about the manner in which the information will be synchronized. For example, in a first embodiment, the program code may determine that a complete row must be synchronized. In alternative example embodiments, the program code may determine that a data element need not be synchronized. In still other example embodiments, the program code may determine that the data element should be synchronized during the next regularly scheduled synchronization, while in other instances, the decision may be made to immediately synchronize the data.

Support for the EXEC command may be implemented in the Expression Language. The format of this command takes on two forms:

EXEC(“Friendly Handler Name”)

EXEC(“Friendly Handler Name”, Variable Argument List)
Where “Friendly Handler Name” is the name associated with the Handler in the System Object Table created during Handler Registration. The variable argument list allows for the entry of additional parameters to control operations with the Extension Manager's interactions with the Handler. These arguments take the form of control flags or Handler Property values that are passed through the system.
   EXEC Command

Another method for invoking a plug-in within the synchronization system is through use of what is referred to herein as an EXEC function or command. An EXEC function is a particular mechanism that triggers a plug-in to execute. For instance, an EXEC command can be used for Field Selection calculations, Validation Expressions, and other calculations required within an application plug-in.

In one embodiment, the EXEC function is triggered by a particular (“EXEC”) event that is managed by the extension manager. The extension manager causes a particular plug-in (or plug-ins) to execute upon receipt of an EXEC event. In some embodiments of the invention, the extension manager may call a function that calculates an expression (see above).

Plug-ins allow the extension of the integrated expression language available in synchronization system-based applications. These extensions are referred to herein as custom expressions. The purpose of custom expressions is two-fold:
1. To allow custom computations to occur. For example, a custom NPV expression could be calculated.
2. To allow custom form-level behavior based on the state and/or values of fields on the form.

For example, consider the following XML message:

<EventHandler Type=“Select”>
<Form Name=“UserInput” ID=“{guid}”>

```
<Tab Name=“Tab1” Enabled=“1” Visible=“1”>
  <Field Name=“Field1” Enabled=“1” Visible=“1”>Value1</Field>
  <Field Name=“Field2” Enabled=“1” Visible=“1”>Value2</Field>
</Tab>
```

</Form>
</EventHandler>

The above fragment is passed as a parameter to the event handler. The event handler is free to do whatever processing the event handler deems appropriate. In order to return results to the expression engine, the called handler simply transforms the XML and returns the transformed XML

For example, to disable the second field on the form the handler may return the following fragment:

<EventHandler Type=“Select”>
<Form Name=“UserInput” ID=“{guid}”>

```
<Tab Name=“Tab1”>
  <Field Name=“Field1” Enabled=“1” Visible=“1”>Value1</Field>
  <Field Name=“Field2” Enabled=“0” Visible=“1”>Value2</Field>
</Tab>
```

</Form>
</EventHandler>

For example, to return a different value for a field, the handler may return the following fragment:

<EventHandler Type=“Select”>
<Form Name=“UserInput” ID=“{guid}”>

```
<Tab Name=“Tab1” Enabled=“1” Visible=“1”>
  <Field Name=“Field1” Enabled=“1”
  Visible=“1” >New Value</Field>
  <Field Name=“Field2” Enabled=“1”
  Visible=“1”/>Value2</Field>
</Tab>
```

</Form>
</EventHandler>

Form Buttons

One method for associating a plug-in within the synchronization system is through association of the plug-in with one or more form buttons. Form buttons are buttons placed on an appropriate synchronization system form that are associated with business logic upon clicking upon the button with the mouse. For example, a form button can be programmed to launch a program, run a macro, trigger an external process, launch a custom printing job, and/or interact with web services. Incorporation of form buttons into synchronization system-based applications allows a user to have access to important programs and/or information that are necessary for the maximized use of a particular synchronization system-based application. In some embodiments, a form button is associated with an event (see below), which is in turn associated with one or more plug-ins. In other embodiments, a form button is directly associated with a plug-in, which is called when the button is pressed.

Events

According to one embodiment of the present invention, execution of plug-ins may be contextually sensitive to any particular event, either external or internal to the synchronization system and/or the plug-in. The ability to associate one or more plug-ins with any particular type or class of event enables the system to more efficiently manage the resources associated to a particular synchronization system-based application and/or function. In this manner, the system supports the ability to only display specific plug-ins for specific events within one or more synchronization system-based applications. For instance, only a plug-in that has been registered as an alternate form can be used to display data upon a record open event. The system can optionally support a wide range of events covering most operations, such as open, save, update, close, menu control, record navigation (next, back, cancel), and expression calculations, just to name a few examples. For example, a plug-in could be triggered by an internal event, such as a user pushing a form button, or by an external event, such as a user scanning a new RFID tag into the system. In fact, any configurable event could initiate the exchange between the synchronization system and one or more plug-ins.

In addition, the Extension Manager may receive synchronization events, such as “Conflict” events that indicate a conflict has occurred during synchronization, synchronization process events (e.g. start of process, permissioning, connection, calculate record set, record transfer, presentation of status, presentation of conflict), which indicate steps in the synchronization process, and other application specific synchronization events as defined by various synchronization applications.

Once an event is triggered, an exchange of information between the plug-in and the synchronization system Extension Manager occurs. The bindings that cause a particular event that trigger a plug-in execution are established within the Extension Manager when a plug-in is registered.

In some embodiments, different types of events are supported. For example, form events, synchronization events, and record events may be supported. Form events are a classification of event related to processing a synchronization system form, and may include events association with specific form buttons (a “form button” event), or associated with opening, loading, saving, or exiting a form (respectively, a “form open,” “form load,” “form save,” and “form exit” event). Functionality may be added or implemented by associating specific handler functions with each event. For example, a custom form editor may be associated with a “form open” event. Record events may encompass, but are not limited to, creating a new record (a “new record” event), opening an existing record (an “open record” event), saving a record (a “save record” event), and/or modifying a record (a “modify record” event). In response to these types of events, a plug-in can be used to pre-process or load new or existing record fields and form attributes associated with either a synchronization system form or an alternate forms editor, which is a plug-in or application that replaces/augments existing synchronization system functionality for displaying forms. Synchronization events are described elsewhere in this document. For example, a doctor at a hospital may open a patient record; opening the patent record produces an “open event.” This event can be associated with a plug-in that executes a query of the system to check and notify the doctor of the known patient's drug allergies. Or, a doctor treating a child with a broken bone may enter the initial diagnosis and course of treatment into the synchronization system, an event that can trigger the system to check to see if the patient has ever had similar problems before, and perhaps uncover a history of physical injuries that could reveal child abuse. Plug-ins associated with events can be programmed to do any type of query, calculation, automatic population of information into a form, etc.

Metadata Extractors

Applications designed to extract metadata from a specific file type. If a metadata extractor is registered with a synchronization system-based application, a function GETMETADATA may automatically attempt to run the plug-in. Alternatively, metadata extractors may be associated with specific file types (see below).

Plug-in Interface

According to one embodiment of the present invention, the plug-in interface is an abstract interface defined by the synchronization system that third party plug-in developers must implement. The IExtensionHandler Interface is defined in AdessoInterfaces.dll, a strong name signed assembly that is available commercially from Adesso Systems. According to one specific implementation, an implementation of a plug-in must implement the IExtensionHandler interface and, in a .NET exemplary embodiment, should be implemented as a “Smart Device Class Library” project. By doing this, the Class file and its implementation can be executed on both the .NET Compact Framework as well as the Full .NET Framework. Implementation in other embodiments, such as using Java, will be understood by the reader on the basis of this description.

Requests to the plug-in are contained in the XmlDocument parameter. Responses from the plug-in are returned in the string return value and must contain the complete XML document with changes made by the plug-in. Requests and responses must follow the XSD definition.

In addition, configuration parameters of a plug-in can be used to make on-the-fly parameters changes to the XML schema of a plug-in. In one embodiment of the invention, plug-ins may be modified by changing and/or augmenting the XML parameters sent with the request to the program. This capability allows a user to specifically customize a plug-in without making permanent changes, registering the program as a new plug-in, or saving distinct instantiations of the same plug-in. The parameters passed can include plug-in startup parameters (e.g. working directory, files to use/include/function on etc.), field mappings (per synchronization system-based application, per user, per device, etc.), optional resource files (graphics, etc.), among other things. All parameters can be configured specifically for a user and/or device, etc. Essentially, this feature allows users to customize their plug-ins for any particular scenario in which that would be advantageous.

An example interface for the ExtensionHandler is provided below

public interface IextensionHandler

{

string Handler(System.Xml.XmlDocument xmlDoc);
string GetFieldNames(XmlDocument xmlDoc);
string GetParameterNames(XmlDocument xmlDoc);

}

The Handler is used for handling all Event types.

GetFieldNames is used for obtaining a list of names to be used in Field Name Mappings.

Request XML

<EventHandler Type=“EventsNOUI” Name=“SpeechEventHandler”

Assembly=“C:\Documents and Settings\mpalone\My
Documents\Visual
Studio

Projects\SpeechEventHandler\bin\Debug\SpeechEventHandler.dll”

Class=“Adesso.Client.SpeechEventHandler”
GUID=“{0E0FA600-97BB-11D9-
305E-005E27860124}”>

<FieldNames />

</EventHandler>

Response XML

<EventHandler Type=“EventsNOUI” Name=“SpeechEventHandler”

Assembly=“C:\Documents and Settings\mpalone\My
Documents\Visual
Studio

Projects\SpeechEventHandler\bin\Debug\SpeechEventHandler.dll”

Class=“Adesso.Client.SpeechEventHandler”
GUID=“{0E0FA600-97BB-11D9-
305E-005E27860124}”>

<FieldNames>

<FieldName>Test1</FieldName>
<FieldName>Test1</FieldName>

</FieldNames>

</EventHandler>

NOTE: If return values for GetParameterNames or GetFieldNames are not desired, return xmlDoc.DocumentElement.OuterXml or a blank string (e.g. Return “ ”;)

string IExtensionHandler.GetParameterNames(XmlDocument xmlDoc)
{

return xmlDoc.DocumentElement.OuterXml;

}

GetParameterNames is used for obtaining a list of parameter names.

Example Request XML Fragment:

<EventHandler Type=“EventsNOUI” Name=“SpeechEventHandler”

Assembly=“C:\Documents and Settings\mpalone\My
Documents\Visual
Studio

Projects\SpeechEventHandler\bin\Debug\SpeechEventHandler.dll”

Class=“Adesso.Client.SpeechEventHandler”
GUID=“{0E0FA600-97BB-11D9-
305E-005E27860124}”>

<ParameterNames />

</EventHandler>

Example Response XML Fragment

<EventHandler Type=“EventsNOUI” Name=“SpeechEventHandler”

Assembly=“C:\Documents and Settings\mpalone\My
Documents\Visual
Studio

Projects\SpeechEventHandler\bin\Debug\SpeechEventHandler.dll”

Class=“Adesso.Client.SpeechEventHandler”
GUID=“{0E0FA600-97BB-11D9-
305E-005E27860124}”>

<ParameterNames>

<ParameterName>Test1</ParameterName>
<ParameterName>Test2</ParameterName>

</ParameterNames>

</EventHandler>

NOTE: If return values for GetParameterNames or GetFieldNames are not desired, return xmlDoc.DocumentElement.OuterXml or a blank string (e.g. Return “ ”;)

string IExtensionHandler.GetParameterNames(XmlDocument xmlDoc)
{

return xmlDoc.DocumentElement.OuterXml;

}

In one embodiment of the present invention, the synchronization system XML interface has many optional security features to protect data as necessary. In one aspect of the invention, it is possible to encrypt the file stream memory, as well as encryption of the XML response/request files. Additionally, after the synchronous execution of the request/response files occur, and the plug-in returns a value to the synchronization system-based application, the files are automatically deleted, and the memory is cleared. In one example embodiment, the XML Request and Response file is preferably cleared after each synchronous operation with the plug-in unless the NoClearSHIMFiles registry setting is set to 1.

Only selected fields may be included in the XML request sent to the plug-in. The net result is time and memory saved on devices running the synchronization system, which enhances performance. Another aspect of this invention includes allowing users to augment the XML parameters of request file sent to the plug-in process. Identification of additional parameters allows the plug-in's capabilities to be extended and its usefulness to the user to be enhanced. In addition, by modifying the <params> of the XML request file, multiple plug-ins can be launched with a single user action.

Processes supported by the extensible synchronization system and plug-ins may include, for example:

Synchronization System Binding of Applications and Plug-Ins.

The synchronization system is a late-binding automation process. Binding is a process of matching a particular function to the actual code that implements that function. Something is technically bound when a synchronization system-based application is compiled and all functions called in code must be bound before code can be executed. Early binding is when the program knows in advance, usually during compilation, what the code will execute and the experience will be. Late binding is when the exact properties, methods, or experience is determined at run time. Within the synchronization system platform, the forms, views, permissions, sync rules, etc. may be interpreted at run time, and only at that point-in-time is the actual synchronization system-based application experience determined. This includes the creation of user interface elements, such as views and forms for navigating, creating, and editing data, and enforcing permissions around what operations a user or device is allowed to perform at that particular time. Because of this architectural approach, all of the synchronization system-based application elements are simply stored as ‘data’ within the database rather than compiled into the code. This approach, coupled with other important architectural implementations, is why synchronization system-based applications built on the synchronization system platform can support iterative changes, including changes to the user interface, permissions, data distribution rules, etc., without having to update the synchronization system client or server object code.

Plug-ins and related resources, as described herein, are stored within a synchronization system-based application database along with other elements of the synchronization system-based application schema. In similar fashion, plug-ins are not compiled or linked into the synchronization system platform object code, and are late-bound to the synchronization system-based application at run time thru the above-described mechanisms. Much like a view or a form, the synchronization system platform optionally calls a plug-in only at the moment the synchronization system-based application requires. The system can support several optimization techniques, if deemed useful, including pre-loading a plug-in at various stages of synchronization system-based application execution depending on synchronization system-based application requirements. For instance, if a plug-in is a fairly large object, it might be more user-friendly or allow better performance of the synchronization system-based application if the plug-in is copied to a temporary working directory before it is actually needed. For example, the plug-in could be copied or loaded only when a synchronization system-based application including the plug-in is first opened, the table is first read, or some other event occurs signaling the potential need for a plug-in. However loaded, the notion is that the plug-in only is called and executed at or close to the time of need, and not beforehand.

Because of the synchronization system's loosely coupled approach, it is possible to make changes to plug-in(s), iteratively if needed, without updating the synchronization system client code to support the new or revised program. Upon synchronization, the system compares changes to the schema, and only if the synchronization and permission rules allow is a plug-in that needs to be distributed sent along to the device. The same model applies to plug-in resources as well. If a particular resource associated to a plug-in has been modified, then the system goes through the same process to determine to whom and in what instantiation the related resource should be distributed. In this manner, a synchronization system-based application is self-forming in that it is constructed only of that information-data and synchronization system-based application design components—that are needed to run that synchronization system—based application for that specific user or device. This is the same with plug-ins in that only the programs that are needed on a particular device for which the user has permission to use are distributed.

Permissions Associated to Plug-Ins

An aspect of the synchronization system is the ability to define, at a very granular level, what information users can read, modify, delete, export, and/or share, etc. Assigning permissions is a part of the overall synchronization process. Permissions can be assigned to one or more logical entities, including users, user groups, devices, and/or programs. The combination of synchronization rules coupled with permissions creates the overall process for determining what data flows to what device and/or user, and when. Some of the more granular permissions include the ability to define whether a user or device has the right to read a table column, add records, delete records, modify records, modify own records, and/or change the synchronization system-based application schema, including plug-in related configuration and design. In addition to enforcement at the synchronization system-based application level, the synchronization process optionally can enforce permissions. If a synchronization rule was simple in nature (i.e. synchronize table X), then the synchronization process could enforce the appropriate permission by sending down only the data that the user and/or device had permissions for within table X. For instance, if a user has been given read permissions for all but field Y within table X, then all data except data related to field Y would be transferred upon synchronization. Plug-ins, like other synchronization system-based application components, optionally also can have permissions assigned to them. As such, if a user or device does not have permission to access a particular plug-in, then the system automatically does not distribute that synchronization system-based application schema element even though there was no specific synchronization rule detailing this constraint.

By allowing multiple configurations of plug-ins, users can associate selective plug-in capabilities with specific synchronization system-based application configurations and/or execution environments. For example, within the synchronization system, each user, or group of users, can be assigned unique access privileges to limit their viewing and/or limit the ability to alter specific areas, tables, views, form, filters, etc. of a synchronization system-based application or plug-in. Equivalently, the functionality available through a plug-in can be customized for specific users or groups of users. So, while the district manager for a company may have full access to a plug-in, a field sales associate only may have limited access to it. However, when executing a plug-in related to a specific iteration of a synchronization system-based application, the plug-in is limited in its execution to the data to which the user has access, based on the user's permissions and/or role within the synchronization system-based application. Additionally, it is possible to assign specific permissions, rights, and/or roles to a plug-in, as well as the overall synchronization system-based application, based on user, device, location, etc. So not only can synchronization system-based application and/or plug-in usage be controlled through permissions, but distribution of them can be controlled through the use of multiple variables as well.

For example, a plug-in could be configured to launch a series of applications upon opening a particular synchronization system-based application: 1) an Excel spreadsheet showing the net sales of every member of a particular division, including the total commission due to each employee; 2) a graph showing a comparison in revenue between the present quarter and the four preceding it; and 3) a query to notify the user of any likely customer leads entered into the system in the last fifteen days. While the district manager may have access to all of this information, the field sales associate only may have access to part of document one (showing only his personal sales total and commissions within Excel workbook), have no access to document two (the graph), and have complete access to document three (the new sales leads). Customization of plug-ins, through control of access to certain portions of plug-in functionality and/or results based on the type of user, device, location, etc., allows the synchronization system to be used to reflect the business logic and processes of the particular company using it, and provides easy modification of all the custom settings, the plug-ins, and the underlying synchronization system-based application.

The above example shows the potential complexity of permissions that can be assigned to various users, and shows the synchronization system's ability to provide customized access to synchronization system-based applications and their associated plug-ins. However, the complexity of the results that can be reached through the synchronization system stands in sharp contrast to the ease with which the permissions, synchronization settings, plug-ins, and/or synchronization system-based applications can be set up and/or modified. All custom settings can be changed at any time, as many times as necessary, and are updated and distributed upon sync.

Deployment Management

The synchronization system extension mechanism and plug-in architecture provide a mechanism for an automated application deployment system to clients of the synchronization system. As described above, each plug-in, configuration parameters for the plug-in, and related resources, such as attachments, images and/or any associated file dependencies to the plug-in are stored within a synchronization system-based database. In this manner, with all the parts of a plug-in (or synchronization system-based application) stored within a synchronized database, the synchronization system may be used to manage the distribution of each component to synchronization system clients as dictated by the synchronization and permission rules.

One aspect of the present invention is in the ability not only to extend or enhance the synchronization system-based application through custom programs, but also to ease the distribution and update that comes with plug-ins being treated as an extension of the synchronization system platform, and more specifically the synchronization system-based application schema. The synchronization process seamlessly distributes the plug-in files to any and all devices that require them and have permissions to use them. If a plug-in has been updated, the synchronization system-based application automatically updates the design with the new plug-in and any appropriate related resources at the next synchronization. Further, each device entitled to synchronize with the specific database automatically receives the new plug-in and automatically removes the old one. Furthermore, the associations of the synchronization system-based application or plug with events or other invocation mechanisms are distributed at the same time as the application or plug-in components, eliminating the need for further installation or registration steps on each client.

Each new synchronization system-based application or plug-in is ready for use immediately post synchronization and neither the user nor system administrator has to deal with any program or file installation, because the synchronization system platform manages all the necessary tasks.

Secure Plug-In Distribution with Digital Signature

According to one embodiment, a system is provided that supports the ability not only to efficiently and easily distribute plug-ins, applications, and components that extend or enhance the platform, but to do so in a secure manner. When an authorized designer configures a plug-in within a synchronization system-based application, it is registered, digitally signed, and stored within an encrypted, secure repository for safe keeping at each location it is stored in a database instance. Upon execution of a plug-in, or as indicated earlier, upon loading of a plug-in, the system optionally verifies the digital signature of the program during its first execution, and optionally upon subsequent executions, if configured to do so by the user or administrator. Advanced security features include storage of the plug-in within an encrypted store, as well as the verification that the plug-in has not been tampered with by validating the digital signature against the program itself prior to invocation by the extension manager or SHIM. These features offer tremendous security benefits that would otherwise be very costly to implement and maintain. There are several algorithms that can be used for validating that the plug-in was not modified since distribution (and each has their pros and cons) but the system can employ one or more hash, digital signature, or other non-repudiation capabilities. Use of these types of techniques is well understood to those skilled in art of developing and distributing application components.

Plug-In and Application Versioning in Distribution Control

The synchronization system provides an ability to associate attributes with each synchronization system-based application and plug-in, including associating an attribute that represents a version number with each synchronization system-based application and plug-in. In this manner, it is possible to identify a particular version of a plug-in and synchronization system-based application, and further define synchronization rules such that compatible versions of plug-in and synchronization system-based application are distributed together. The synchronization process further leverages this information to determine what, if anything, needs to be distributed in order to maintain an appropriately configured system across all distributed devices and servers. Each plug-in can specify synchronization system-based application components required for successful operation. A synchronization system-based application can specify a particular version of a plug-in to support specific functionality. This information can be leveraged at synchronization system-based application run time and/or device synchronization. In one embodiment of the present invention, integration of a plug-in with each desired synchronization system-based application is done through a registration process, via the synchronization system Designer. Each plug-in, or schema element therein, can be associated with one or more distributed synchronization system-based applications. Registration requires identifying the particular plug-in and associating it with a specific design element within the synchronization system-based application. By using the synchronization system's GUID-based mechanism to identify and link schema elements of plug-ins, each element can be versioned and synchronized across any/all synchronization system-based applications. Furthermore, each schema element can be managed and abstracted from any particular physical implementation of the synchronization system-based application. A benefit of abstraction of the integration of a plug-in with each synchronization system-based application is that any part of the Plug-in(s) associated with a synchronization system-based application and/or the synchronization system-based application itself can be altered without losing the integration of the pieces. Plug-ins also can be shared among synchronization system-based applications, and/or be a shared resource within a synchronization system-based application. Thus, in one aspect of the invention, the extension and enhancement of synchronization system-based applications can leverage one or more plug-ins.

Profile Settings for Dynamic Distribution and Execution

Additionally, through the customization of profile settings, one embodiment of the invention allows profile-based plug-in execution and distribution. This is done by associating specific attributes to the plug-in, programmatically or via a provisioning interface (i.e., though the management console or designer component of the synchronization system). The plug-in can leverage several parameters available from the platform or other systems or data sources, including the synchronization system-based application data itself (a self-configuring execution model based on the current state of an synchronization system-based application data set), including user name, the group or groups (with rules for hierarchy of group-based enforcement, meaning if user or device is listed in more than one group with contradictory permissions, the system can be configured to determine hierarchy of privilege enforcement) associated with a particular user, the device on which the synchronization system is running, the location of the device, peripheral devices attached (such as a physical security token system that would involve one type of security plug-in whereas a software-based security token might invoke a different plug-in or function within a plug-in) and/or special parameter settings, among other variables or environmental factors. The profile-based plug-in execution can lead a plug-in to perform a specific function or set of functions, and/or to not execute for a particular synchronization system-based application and/or on a particular device.

Extensible Management of Synchronization

The extensible synchronization system architecture provides a mechanism for providing an extensible synchronization mechanism in which various aspects of the synchronization process may be dynamically customized. In a first example embodiment, plug-ins support the provision of extensible synchronization system-based applications. Specifically, synchronization system-based applications may be extended after they are deployed, and the synchronization of the extensions and any resulting data may be automatically handled at least in part by the plug-in. Plug-ins may provide complete synchronization support, or may provide only a part of the required support and rely on the extension manager and synchronization system to provide the balance of the synchronization mechanism. Similarly, a plug-in may provide support to a plurality of synchronized system applications and databases, and may include cross-synchronization between applications and databases, which may in turn be synchronized. The scope of the solution may include support for creating, modifying, and deleting record instances within a distributed environment while encompassing one or more database instances distributed amongst one or more devices.

The synchronization system supports any particular instance of the database or databases on any particular device or devices which contain a super-set, sub-set, or same-set of records at any given point in time. The GUID-based synchronization mechanisms allow the merging of database instances through synchronization via manual or programmatic formulas, and the extension system permits the dynamic extension of these formulas on an application-by-application basis. The formulas can be based on content within a record instance, data within different record or records within a database, one or more databases, and/or attributes associated with an application or group of applications.

By associating one or more plug-ins with specific events and distributing the plug-ins to different devices, differing synchronization formulas may be distributed to different devices or classes of devices. Thus, the behavior of a first device may be made different from the behavior of a second device. Similarly, the synchronization behavior of each device may thus be customized in order to account for differences in business practices or purpose of the device. This permits a device that is mostly operating using read-only data to be synchronized differently than a device that is mostly operating in a mode in which the information is continuously being operated. Differences in synchronization behavior may include timing in which a first device synchronizes every hour, and a second device synchronizes at the earlier of each hour and when a record is changed.

For example, the content for a user on their office computer may contain a super-set of synchronized records, allowing all information for which the user has permissions to access to be available on that format. However, the same user may only have a sub-set of records on their personal PC, limiting the information that is stored and displayed on a device with finite memory and processing capabilities. In addition, the synchronization of the different instantiations of the same database can be customized per user, per device, per location, etc.

GUID-Based Database Synchronization Management

The synchronization system platform uses GUIDs to isolate, abstract, and manage the database implementation from business logic, from the presentation of the synchronization system-based applications to the end user. Database elements, including fields, tables, records, etc. use GUIDs, as do synchronization system-based application elements such as controls, sync rules, etc. Due to the use of GUIDs, the various layers of the synchronization system platform (database, business logic, etc.) can be changed independently, and the synchronization system manages the changes as appropriate. Additionally, the synchronization system supports a late-binding approach to forms, views, etc. such that only upon actually opening of a synchronization system-based application table, view, or record does the system assemble the needed components. Because these are loosely coupled with one another, they easily can be individually added/changed/deleted without having to simultaneously update all of them. For example, a database field can be renamed without having to update the form that displays it because the synchronization system manages the relationship between presentation and the database.

In one specific example, each plug-in is associated with the field name map GUID layer that is then linked to the synchronization system-based application. This process uniquely identifies the schema elements of the synchronization system-based application, including the plug-in, thus later enabling the plug-in to be versioned and synchronized across one or more distributed devices. By relating the plug-in schema elements to a GUID layer, which is further related to the synchronization system's name, field, form, etc. within the synchronization system-based application, the links that are created can not be “broken” upon change of the synchronization system's data or metadata. The system abstracts the actual plug-in from any physical representation, optionally including the plug-in name itself, by assigning a schema element GUID, which is then used to manage and distribute the plug-in within the synchronization system platform's synchronization and synchronization system-based application download processes as well as permission assignments—including access control and use permissions such as execute, modify (parameters, related resource files, etc.), and update.

A direct result of the GUID-based record identification employed by the synchronization system is that the system allows the possibility to change some or all the content within each uniquely identified record. In this manner, regardless of changes to a record, the synchronization system has the means to evaluate changes from multiple instantiations across one or more devices to determine what changes were made to each record instance. The synchronization system can determine the delta between record instances and manually or programmatically determine what, if any, actions are necessary to combine/validate data from each instance. As data types become more complex, the ability of the system to predetermine all types of synchronization behavior becomes impossible to manage.

An alternative approach, utilizing the extensible capabilities of the synchronization system herein described, is to extract at least part of the synchronization behaviors into one or more plug-ins and distribute these plug-ins as needed. As such, the size and complexity of the synchronization system may remain limited, while being flexible enough to support a range of needs from record synchronization and data formatting, to synchronization decisions regarding aspects of synchronization such as timing, elements to synchronize, to complete synchronization with external systems.

One particular useful feature is the ability to define extensible conflict control mechanisms in support of synchronization mechanisms. Conflicts occur when two or more users and/or applications modify the same data at the record and/or field level. The resolution of conflicts is focused primarily on both data integrity and data loss as it relates to the business requirements at hand. One embodiment of the invention supports a configurable method, which can be manual or programmatic, for resolving or dealing with conflict resolutions. In this embodiment of the invention, there are simple methods whereby a particular device or server “wins” (i.e., the record and/or field that wins is kept while the other is discarded). Additionally, the system optionally can keep both sets of conflicting data. In a third option, the system also can prompt the user to choose which set to save among conflicting data sets. Similar to the synchronization rules, it is possible to establish additional logic using SQL or other functions to further analyze the condition of the conflict, using data involved in the conflict or other data, internally or externally to the synchronization system-based application.

According to one embodiment of the invention, an ability to distribute plug-ins is provided that can be used to provide custom, synchronization system-based application-specific conflict resolution logic. For example, during the synchronization process, the system can determine there is a conflict based on information available such as table type, record type, record contents, or other information. Once a conflict is found, the system can call one or more plug-ins to implement customer logic using data from the conflict records (or fields), as well as other data within or external to the synchronization system-based application. In this embodiment, the system would first pass the relevant data to the plug-in and allow it to determine the appropriate course of action, either by executing a program or some other function, including soliciting user input. The plug-in could optionally resolve the conflict directly, by updating, deleting, or creating fields and/or records as needed, because the extension manager is configured to pass along the appropriate data and/or references to data. Optionally, the plug-in could pass back specific instructions to the synchronization system indicating similar actions for the synchronization system platform to perform on its behalf.

Application databases may change over time, both in content (data) and in structure. One advantage of the extensible synchronization management mechanism described above is that both the content and the data definitions (schema) are stored within the synchronized database and elements of each are represented using unique GUIDs. Thus, each data element is associated using these GUIDs within the synchronization level, and at the database element name level to the application logic. This permits the synchronization system to manage the mapping between GUID element and database element name independently. By managing these elements independently, the synchronization system allows different versions of applications to share application data, even if the application data does not share names within a database schema. Thus, a first application may refer to a telephone number element as “phone number” and a second application may refer to the same field as “telephone number”. The applications may be enabled to share a common set of data by mapping the two application specific names in the schema to a specific synchronized database column element using the column element's GUID, and then further manage the synchronization of data rows associated with this column using each rows' GUID. Additionally, the synchronization system may be extended so that the a record instance on any device or devices may contain a super-set, sub-set, or same-set of fields within that record at any given point in time.

Similarly, the GUID-based approach permits the synchronized application and/or plug-in to determine the underlying version of the synchronized database and make necessary adjustments to the database and/or data stored within the database. The GUID-based approach permits applications and/or plug-ins to add, delete, or modify the application schema on an as-needed (and as-permitted) basis, and, furthermore, to make data formatting decisions during storage, retrieval, or synchronization. For example, if a plug-in is operating with a first version of a synchronized system application, the plug-in would format a telephone number using European telephone number formatting conventions, while if the same plug-in was operating with a second version of the synchronized system application, the plug-in would format a telephone using an American telephone number formatting convention. The version of the synchronized system application may be determined using an attribute or aspect of the application itself, or from an attribute or aspect of one or more databases or components associated with the application.

Plurality of Synchronization Mechanisms

One advantage of the present invention is that each specific device may be configured independently to synchronize a synchronized database with a plurality of backend systems. In an example embodiment, a first plug-in may be utilized to synchronize at least some elements of a synchronized database with a first backend system, and a second plug-in may be used to synchronize at least some elements of a synchronized database with a second backend system. The first backend system might be a web-service based repository, and the second backend system might be database application. Different plug-ins can provide independent synchronization to differing backend applications.

METADATA Insertion/Extraction Synchronization System-Based Application Plug-Ins

A further particular use of a plug-in within a synchronization system is through use of metadata extractors and/or inserters. Metadata plug-ins are specialized applications that can “crack” open and read from files or “crack” a file and insert data into a file, according to customizable protocols or formats based on the file type. A list of filename file types that each metadata plug-in is associated with must be created at the time the metadata plug-in is registered (see below for exemplary user interface and process). The process of extracting metadata from a file entails knowing the file format and finding the relevant information (metadata) that is embedded within it. The metadata insertion process works in similar fashion in that the process involves knowing the file format, and finding the relevant places to insert the information (metadata) to embed the information within the file. Each file type (MP3, jpeg, etc.) may have one or more specialized metadata plug-in(s) associated with it to access or write the embedded information. Customized extraction or insertion of specific types of metadata can be achieved. In this embodiment of the invention, the ability to customize the metadata plug-in fulfills business and consumer goals by allowing the extraction or insertion of only the pertinent information without wasting time, effort or processing power working with information (metadata) that is of no use to the particular process being performed. Extracted data can be written out to a file in order to add or update existing information within the synchronization system-based application.

Metadata plug-ins obtain data from the Params section of the XML used to invoke them (see above). The parameters sent for the metadata extractor are:
InputFile
Attributes (optional)

These parameters may be entered during registration, or may be provided from the context in which the metadata plug-in is called from.

File Type Identification for Association Metadata Plug-Ins

File types are usually designated by a section of the file name, typically following the last ‘.’ within the file name, and often referred to as the file extension. Examples include: .htm, .doc, .xls, .txt, .xml, .csv, .flg, .jpg, .wmv, etc. While these designations are helpful, the synchronization system also can employ appropriate metadata plug-ins even if the actual data within the file differs from the format specified by the file extension (i.e., a user accidentally (or purposefully) renames a file with the incorrect file extension). In this instance, the ability is provided to include one or more file format identification techniques in order to provide as robust or delicate format identification as is necessary, including none.

To facilitate the identification file types, the synchronization system may look for the presence of a special constant or arrangement of bits to identify file purpose and/or format. The synchronization system can use these bit tags, but such constants would most likely be nonsensical to any other but the targeted program. These bits could be represented in any number of representations, including ASCII, hexadecimal, etc.

In one embodiment of the invention, the synchronization system also can leverage hash functions to uniquely identify a particular file (i.e., use the file binary as input to a hash function that produces a digest that can be used to accurately identify the file). In addition, it is possible to incorporate more secure cryptographic hash functions, such as MD5 or SHA-1, to both identify and also offer users assurances of the integrity of the entity.

Any of the above techniques, or any combination thereof, may be used to accurately identify the appropriate metadata plug-in extraction or insertion program to be used. Once the file type is identified, the metadata plug-in can be customized to retrieve or insert only the desired metadata. For example, an MP3 file may have information as to recording artist, title, playing time, size of file, producer, copyright holder, etc. embedded within the file. By running a metadata extractor program, this information can be accessed and populated into a synchronization system table. Similarly, use of a customized metadata extractor program would be able to retrieve only selected information and return it to the user (i.e., title, artist, and running time only). Return of metadata extracted can be done by populating a record within a view, printing information, presenting it on screen, playing it, etc.

The metadata extraction or insertion process can execute locally or remotely on the server or other select client devices. It is possible to leverage the synchronization system's synchronization engine to aggregate entities to one or more systems that are designated for extracting or inserting metadata. Specific routing logic can be configured based on the availability or not of metadata within the record. If none exists, then the entity and/or record is routed to a particular server, client or device. According to one embodiment, the ability to perform server-side metadata extraction is provided with the advantage being a predictable metadata extraction experience, since the invention supports a multitude of client devices and each has varying capabilities relative to program execution for specific entities.

Creation, Registration and Integration of Plug-Ins

In one embodiment of the present invention, integrating a plug-in with a synchronization system-based application requires the user to program the link using boilerplate XML code provided by the synchronization system. In another embodiment of the present invention, selective plug-ins can be available as part of the synchronization system software bundle. For example, standardized metadata extractors for common file types, plug-in links for common programs (i.e., reporting programs, finance programs, HR programs, etc.), linking disparate synchronization system-based applications, among others, are available to synchronization system users. In yet another embodiment of the present invention, the process of registering plug-ins is done through a form where the necessary code is auto-generated behind the scenes. This embodiment of the invention allows for any plug-in, whether commonly used or unique, to be integrated with a synchronization system-based application.

Once the design of a plug-in is complete, the plug-in must be registered with each synchronization system-based application that it is intended to work with. Registering the plug-in is a multi-step process that involves identifying the plug-in in the synchronization system plug-in Designer and also associating the plug-in with one or more specific design elements (for example, the view from which a new record event causes the plug-in to run).

Registration, in general, is a process by which a plug-in is stored within a distributed database, and all necessary associations required to use the plug-in with existing synchronization system applications are made and stored in the same or different distributed database. In some aspects of the invention, registration is performed automatically with predefined associations installed as part of the plug-in application (e.g. metadata extractor plug-ins). In other exemplary embodiments, the user must create the associations between a plug-in and a synchronization system application. The following shows an exemplary user interface for registering a plug-in and making associations that are subsequently stored in a distributed database. The following exemplary material assumes that the user has been granted appropriate database permissions to change the design of the synchronization system-based application.

Plug-In Designer

The “plug-in designer” application is an example application that permits a user to configure plug-in applications within a synchronization system. The plug-in designer may be used at any location where a distributed database is present. In some example embodiments, the plug-in designer is provided as part of the synchronization system's application designer application. In these embodiments, the plug-in Designer is accessed by selecting plug-ins from the synchronization system-based application designer and then clicking the New button. This illustrative example assumes that the plug-in designer has been integrated with an application designer application that is deployed on a Windows-based system and is used to deploy .NET-based assemblies as plug-in applications.

In one embodiment of the invention, regardless of the form of registration, when a plug-in is registered within the synchronization system, many properties are associated with it. Simple properties include a “qualified name” that the user picks, a class name (the namespace used within the implementation of the plug-in assembly) usually based on the company name, the plug-in type (form button, metadata extractor, etc.), and the size of the file. In addition, each plug-in is assigned a unique ID, such as an MD5 hash value, for use in identifying the plug-in during the instantiation of the program. In one aspect of this invention, synchronization system plug-in registration comes equipped with advanced properties such as the field filter option. This feature allows a user to select among the available fields from an individual synchronization system table to associate with a particular plug-in. The result of the field filter option is to minimize the number of fields that the synchronization system has to update or check upon sync.

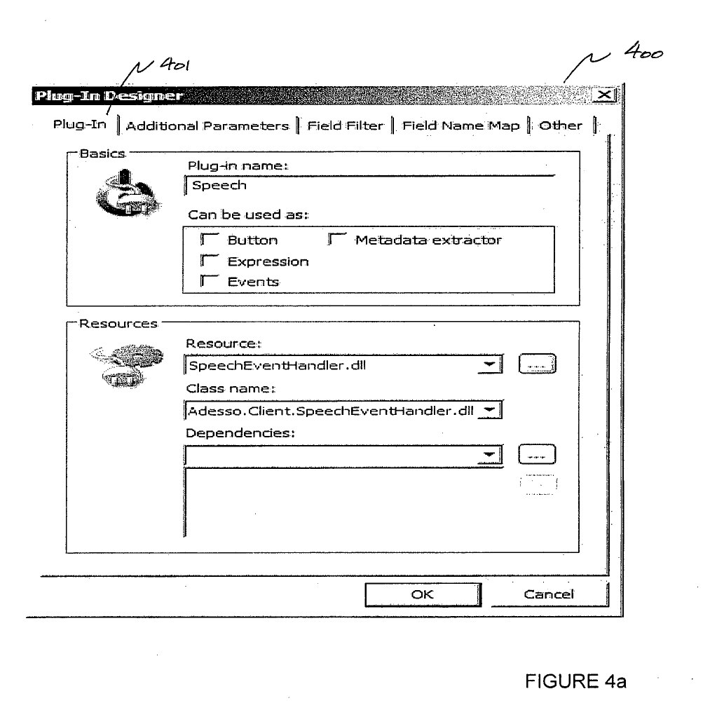

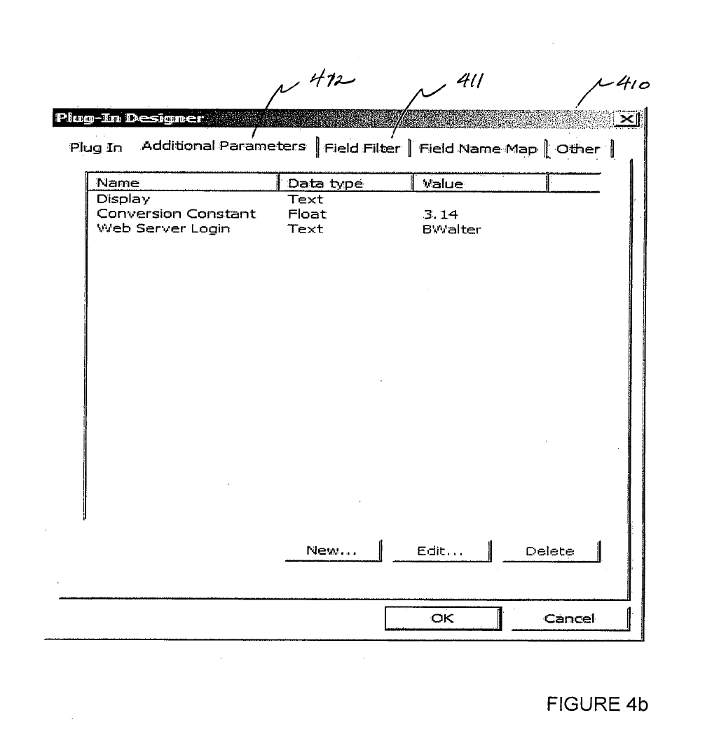

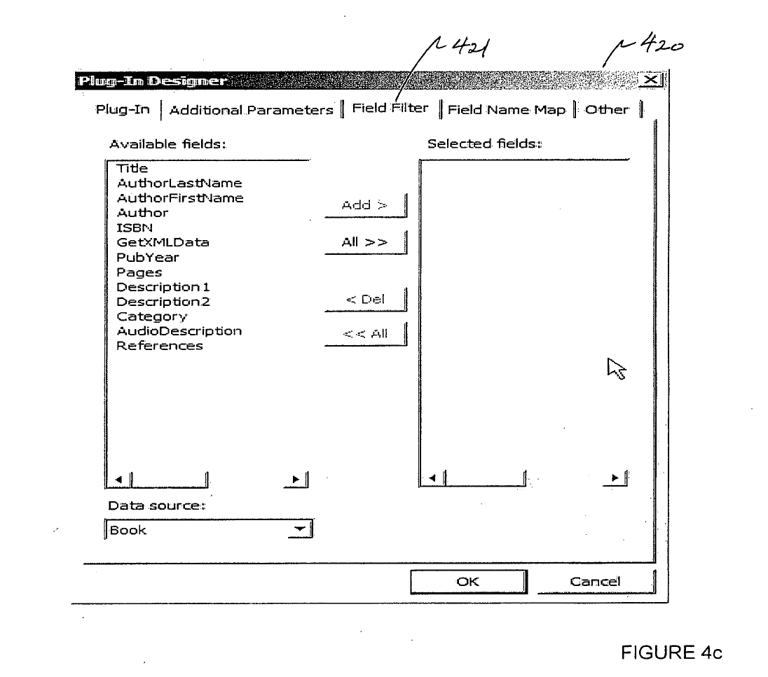

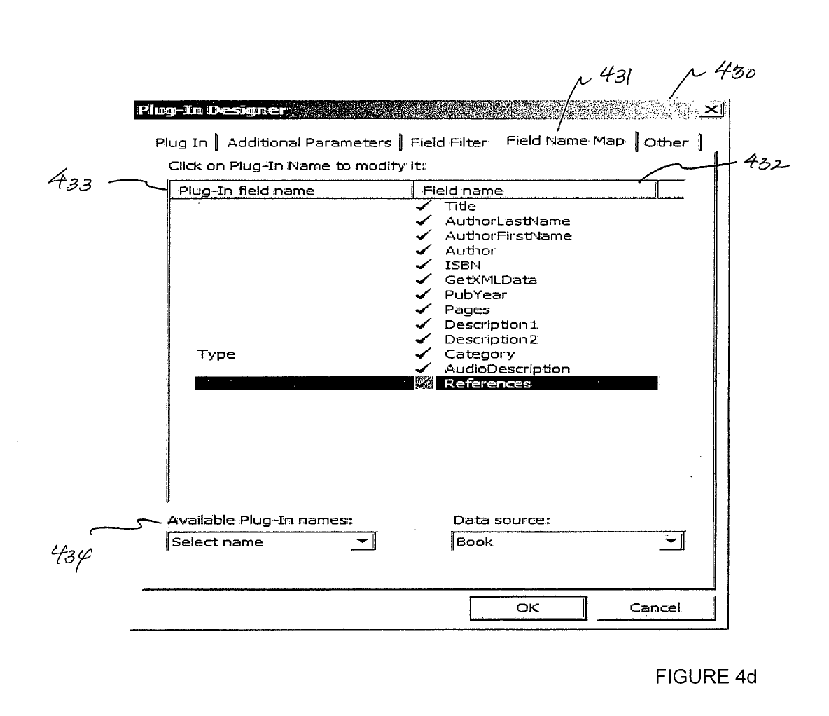

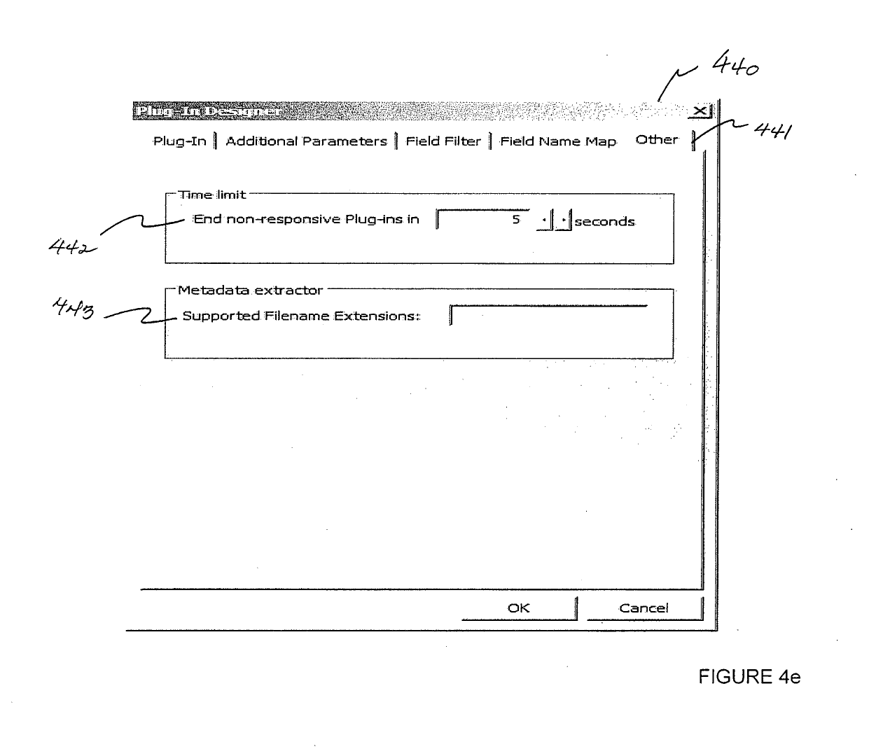

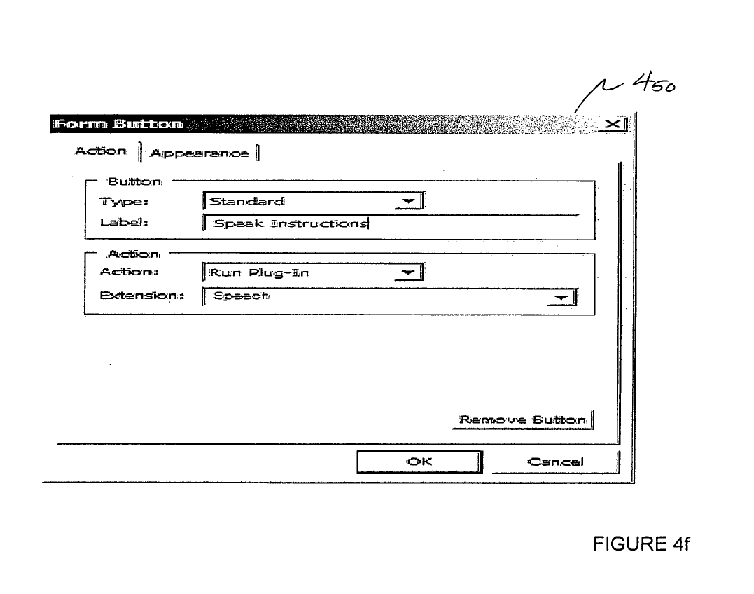

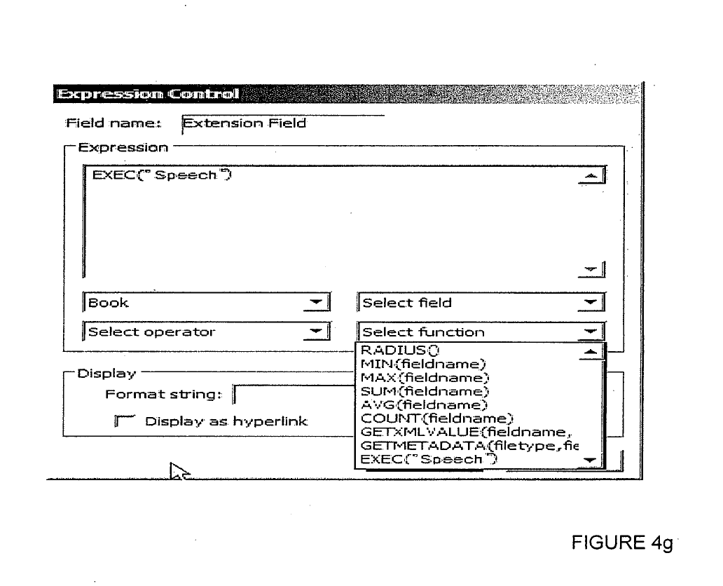

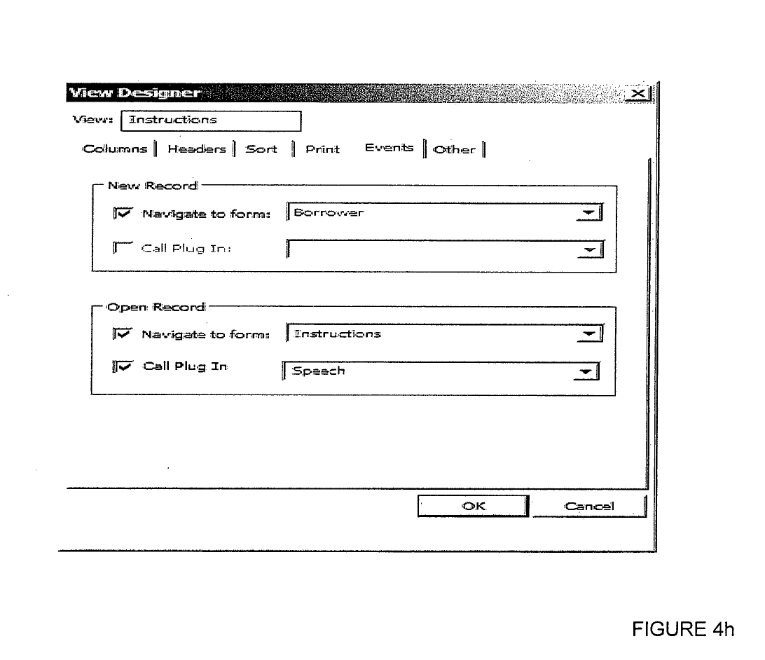

When users create a new plug-in or open a selected plug-in, they may be presented with a plug-in Designer dialog interface similar to interface 400 shown in FIG. 4a. In a plug-in tab 401, the user is prompted to enter the following fields:
Plug-in name—The “user friendly” display name that may be changed at any time.
Can be used as—A list of supported Types for a plug-in. In one example, at least one checkbox must be selected if the plug-in is to be saved without warning. If “Metadata extractor” is selected, typically, it may be the only selection.
File—The File Path of the plug-in Assembly on disk (e.g., storage). The Designer can choose from existing Assembly Resources or select the file selection button to open a new/updated plug-In Assembly from disk.
Class Name—The namespace used within the implementation of the plug-in Assembly. In one example, it may be recommended that Designers qualify the namespace name with their company name. The synchronization system Extension Manager looks for namespaces that start with “Adesso.Client”, so in the implementation of the plug-in, third party class definitions look like the one below.

Note that this field may be automatically filled in after the user selects the Plug-In Assembly File from the File Selection Dialog.

namespace Adesso.Client.Acme
{

class WebServiceEventHandler : IExtensionHandler

{

Therefore, the Class Name entry in the synchronization system Extension Designer is “Acme.WebServiceEventHandler.” “Adesso.Client” may or may not be pre-pended. The Extension Manager inserts the class name if one is not entered during dispatches.
Dependencies—A list control containing additional resource files that the plug-in requires to function correctly. The user can add or delete from the list using the buttons to the right of the list.

The user also may provide parameters to be used by the Extension Manager when calling a plug-in. These parameters may be entered, for example, using the Additional Parameters Tab of the example designer application user interface. The Additional Parameters Tab displays the list of User Defined Parameters that the user wishes to include in the <Params> section of the XML (Described Previously). The user can create new, edit existing, or delete entries from the list. In one example entry, names cannot include commas (,), periods (.), brackets ([ ]s), or pipes (|) In another example, values cannot include commas (,), brackets ([ ]s), or pipes (|). The user may be permitted to enter parameters, including name, data type, values, and other information.

The user also may configure the fields that are provided to the plug-in application by the extension manager. In this example embodiment of a management application, the user might select the “field filter” tab 411 as shown in interface 410 of FIG. 4b and be presented with a user interface screen similar to the interface 420 shown in FIG. 4c. The field filter tab 421 displays the list of available Fields from a selected Table (available in the drop-down list in the bottom left of the dialog) and allows the user to add or delete one or more of them into the list of fields that is included in the XML request sent to the plug-in by the extension manager. If no items are moved from the Available Fields list to Selected Fields list, then all fields may be sent.

The user may configure the field name mapping further between the plug-in application and other field names of synchronization system databases and applications. An example embodiment is shown in FIG. 4d and the example illustrates a mechanism for creating static mappings between field names of a plug-in and an underlying distributed database. In one embodiment, the mappings may be stored in a distributed database and may be synchronized to devices where they are used. In another example, mappings also may be automatically formed on the basis of field names stored in the schema. A Field Name Map tab 430 allows the user to alias synchronization system Field names (e.g., field name 432) with names that the plug-in expects (e.g., plug-in field name 433). This way, if synchronization system Field names change, plug-ins continue to work. The user can select a row to edit to pick from an Available plug-in names drop down list 434. Synchronization system Field names in the right column are displayed for the selected data source table. Checkmarks may be used to indicate the fields that have been selected from the Field Filter Tab. Entries cannot include commas (,), periods (.), brackets ([ ]s), or pipes (|).

The user also may enter parameters that govern operating mechanisms of the synchronization system. The user uses the “other” tab of the exemplary management system user interface. An example user interface 440 triggered by selection of the Other tab is shown in FIG. 4e.

In one embodiment, an “Other” tab 441 is used to set management parameters that govern aspects of the synchronization system extension components, such as the length of time that the extension manager will run an plug-in before assuming that the plug-in is not operating properly and timing out. The selection of parameters in FIG. 4e is exemplary in nature and may include additional or differing parameters associated with different system mechanisms and other device level integration issues. For example, if the plug-in is a metadata extractor, this tab may be used to identify the file types from which the plug-in can extract data.

In the exemplary user interface shown in FIG. 4e, a user can enter two fields. The first field 442 is a configuration parameter for the extension manager in which the configuration of the extension manager's operation is managed. The user enters into the appropriate field in the user interface, a number, in seconds, representing the length of time that the synchronization system attempts to run the plug-in before timing out.

In the second field 443 of the exemplary user interface shown in FIG. 4e, the user enters an integration instruction, specifically, the filename extensions that metadata extractor plug-ins are associated with. Once synchronized with a client device, the client device uses this information to determine, based upon file name, when a plug-in metadata extractor should be called. A user may enter a list of the filename extensions of supported file types for a metadata extractor plug-in. In one example, filename extensions may be entered as alpha/numeric characters only, without a preceding period, with a list of multiple filename extension entries separated by commas. For example, a metadata extractor could be configured to work on two well-known types (BMP, GIF) of picture files by entering the following string into the field of the exemplary user interface:

bmp, gif.

Associating Plug-Ins with Synchronization System Design Elements

After a given plug-in has been registered, it may be associated with various synchronization system client constructs. Within the exemplary management user interface shown above, the user may be presented a screen with a list of Handler Names. As with other synchronization system-based application Designer Selections, the user may be presented New, Reorder, Delete, Open, and Close buttons that are available to be selected. If the user creates a new Handler or opens a selected Handler, they may be presented with a Handler Properties Dialog that contains a Friendly Name Text Box Control, File Selection Control, a Handler Type Control, a Class Name Control, a Field Filter Selection Control, and dynamic Optional Handler Property/Attribute Controls (depending on the Handler Type). If opening an existing Handler, some of the fields may be un-editable. From this, the external third party assembly/BLOB gets stored in a (Binary) Properties Table in the distributed database. Depending on the context of a particular design element, additional UI elements may be introduced to associate the element with the Handler. One aspect of the management user interface may include a “forms designer” component, which lets a user edit the configuration parameters that associates a handler selected (above) with one or more user interface elements of an existing synchronization system application form.

In one example embodiment, the user is presented with a copy of a synchronization system application's user interface form, with additional selections for adding plug-in associations. In this exemplary user interface, the user is presented with the option of adding a validation function (an EXEC function) or associating a button in the existing application with a specific plug-in.

The user is first prompted to select a plug-in to which associations will be made. If the forms designer is called from within a management system such as the exemplary system described above, the selection of plug-in may be made based upon the context of registering a new plug-in. The user uses this method to create the configuration materials that associate a plug-in with a button in a synchronization system form. When selected, the user is presented with a Properties Dialog allowing the selection of one of the available plug-ins of the appropriate type as shown within interface 450 of FIG. 4f.

Similarly, the management interface may be used to configure specific EXEC functions within a plug-in, and to associate the EXEC functions to specific user interface components of the synchronization system application. An example dialog of a management user interface is shown in FIG. 4g.

Similarly, the management interface may be used to associate specific plug-in handlers with specific synchronization system events. The exemplary user interface shown in FIG. 4h illustrates several such associations.

The user management interfaces presented above are designed to be illustrative in nature to help the reader with understanding how plug-in applications of the present invention may be added to a distributed database, associated with an aspect of a synchronization system application, and be deployed by synchronization of the databases between two or more systems.

Distribution Mechanisms Support Both Client-Server and Peer-to-Peer Architectures

By customizing whether, and how, a plug-in is distributed and/or executed, the user can customize the data that is collected and/or distributed within a particular synchronization system-based application. According to one embodiment of the invention, a method is provided for controlling the management and distribution of information and plug-in functionality across a system with multiple users (e.g., two users or twenty thousand users) without direct user/administrator involvement. Once a plug-in has been associated to a particular synchronization system-based application, or set of synchronization system-based applications, it and any related resources are treated as yet another element of the synchronization system-based application schema. In this manner, once the appropriate permissions have been assigned—to forms, views, tables, fields, plug-ins, plug-in dependencies, etc., the system then manages the distribution of the plug-in as an attribute of the synchronization system-based application. Unlike traditional, custom-built programs, developers and administrators do not have to burden themselves with coordinating the distribution, installation and update of a program across a multitude of devices; rather, the system seamlessly distributes, based on system-defined rules (i.e. permissions, access control rights, etc.), during the synchronization process. In this manner, without any involvement of the administrator or the user, (or the developer, for that matter) a synchronization system-based application receives all necessary synchronization system-based application schema components whenever a user synchronizes. One embodiment of the invention supports the notion of a server or hub-based synchronization initiation system such that if a developer, administrator, or other has updated a plug-in-and deemed it an urgent update, for instance—the system could initiate in-band or out-of-band synchronization to update the plug-in and any other synchronization system-based application schema element or synchronization system-based application data. An alternate embodiment of the invention supports the notion of a peer-to-peer topology-based synchronization initiation system such that if a developer, administrator, or other has updated a plug-in, the synchronization system could initiate synchronization with a peer device to update the plug-in and any other synchronization system-based application schema element or synchronization system-based application data without necessarily first synchronizing with a central server.

XML Request Example

The example that follows defines an XML Schema using XSD. XML Requests are sent to the plug-in through the Extension Manager. XML Responses follow this same schema and are sent from the plug-in to the Extension Manager.

NOTE: XML Responses take on this same format with the addition of the optional <error>, <Save>, <FormAction>, and <Result> tags. The return response may also be an empty string (“ ”).

Having thus described several illustrative embodiments, various alterations, modifications and improvements will readily occur to those skilled in the art. Such alterations, modifications, and improvements are intended to be within the spirit and scope of the invention. Accordingly, the foregoing description is by way of example only and is not intended as limiting.

What is claimed is:

1. In a distributed computing system, a computer-implemented method for associating a software component with a software program, the method comprising acts of:
identifying, by an identification layer, the software component within the distributed computing system;
accessing, by the software program, the software component through the identification layer; and
linking the software component to the software program.

2. The method according to claim 1, wherein the act of identifying further comprises an act of uniquely identifying the software component within the distributed computing system.

3. The method according to claim 1, further comprising an act of relating the software component to a database element of the software program.

4. The method according to claim 2, further comprising an act of relating the software component to a database element of the software program using a unique identifier that identifies the software component.

5. The method according to claim 1, wherein the software program is executed by a mobile computing system.

6. The method according to claim 1, wherein the software component includes at least one of a group comprising at least one software program and one or more related data files.

7. The method according to claim 1, further comprising an act of identifying one or more elements of the software program.

8. The method according to claim 7, wherein the act of identifying elements of the software program further comprises an act of uniquely identifying the one or more elements of the software program.

9. The method according to claim 2, wherein the act of identifying further comprises an act of uniquely identifying one or more elements of the software component within the distributed computing system.

10. The method according to claim 5, further comprising an act of downloading, to the mobile computing system, the software component.

11. The method according to claim 10, wherein the act of downloading is performed in response to an occurrence of a contextual event.

12. The method according to claim 1, further comprising an act of synchronizing the software component among a distributed database storing at least two instances of the software component.

13. The method according to claim 12, wherein the at least two instances are located among a plurality of computer systems.

14. The method according to claim 12, wherein the act of synchronizing further comprises and act of determining a difference between two or more instances of said distributed database.

15. The method according to claim 12, further comprising an act of copying a software component associated with a first instance of said distributed database to a second instance of said distributed database.

16. The method according to claim 12, wherein the software component is a plug-in application.

17. The method according to claim 12, wherein the act of synchronizing further comprises an act of comparing at least one dependency of a software component stored in a first instance of the distributed database and at least one dependency of a software component stored in a second instance of the distributed database.

18. The method according to claim 12, wherein the software component has an associated version number, and wherein the act of synchronizing further comprises an act of comparing a version number of a software component stored in a first instance of the distributed database with a version of a software component stored in a second instance of the distributed database.

19. The method according to claim 12, further comprising an act of invoking the software component.

20. The method according to claim 19, wherein the act of invoking the software component further comprises an act of invoking the software component based at least in part on information associating the software component with the software program.

21. The method according to claim 20, further comprising an act of determining a validity of the software component prior to performing the act of invoking the software component.

22. The method according to claim 21, further comprising an act of determining a signature of the software component prior to performing the act of invoking the software component.

23. The method according to claim 19, further comprising an act of associating the software component with a synchronization process.

24. The method according to claim 23, further comprising an act of controlling, by the software component, the synchronization process.

25. The method according to claim 24, further comprising an act of determining, by the software component, whether to synchronize at least one instance of the distributed database.

26. The method according to claim 25, further comprising an act of determining, by the software component, a portion of the at least one instance of the distributed database to be synchronized.

27. The method according to claim 25, further comprising an act of determining, by the software component, when the at least one instance of the distributed database is to be synchronized.

28. The method according to claim 24, further comprising an act of controlling the act of synchronizing the software component among a distributed database storing at least two instances of the software component.

29. The method according to claim 24, further comprising an act of resolving, by the software component, a conflict associated with the act of synchronizing.

30. The method according to claim 1, further comprising an act of mapping a schema element of the software component with a schema element of the distributed database.

31. The method according to claim 30, further comprising an act of mapping a plurality of field names associated with the software component and corresponding fields of the distributed database.

32. The method according to claim 15, wherein the first instance of the distributed database and the second instance of the distributed database are located, respectively, on a client and a server.

33. The method according to claim 15, wherein the first instance of the distributed database and the second instance of the distributed database are located, respectively, on a first peer computer system and a second peer computer system.
